(19) United States
(12) Patent Application Publication
(10) Pub. No.: US 2020/0406578 A1
(43) Pub. Date: Dec. 31, 2020

(54) INCLINED SHEET MATERIAL, PRODUCING METHOD OF INCLINED SHEET MATERIAL, AND EMBOSSING MOLDING MATERIAL

(71) Applicant: TB Kawashima Co., Ltd., Echi-gun (JP)

(72) Inventors: Yuji KAMIDE, Lugoff, SC (US); Yusuke KAWATA, Echi-gun (JP); Mitsuhiko FURUKAWA, Echi-gun (JP)

(73) Assignee: TB Kawashima Co., Ltd., Echi-gun (JP)

(21) Appl. No.: 16/772,685

(22) PCT Filed: Sep. 25, 2018
(86) PCT No.: PCT/JP2018/035509

§ 371 Date: Sep. 8, 2020

(30) Foreign Application Priority Data
Dec. 14, 2017 (JP) 2017-240089

(51) Int. Cl. B32B 3/30; B32B 5/02; B32B 27/12; B32B 38/06; B29C 59/02

(52) U.S. Cl. CPC B32B 3/30; B32B 5/026; B32B 27/12; B29L 2007/002; B29C 59/022; B32B 2605/003; B32B 38/06

(57) ABSTRACT

A sheet material comprises a recessed part and a non-recessed part which are formed on a surface side of a cushion base material. The sheet material comprises a gradual changing part in which a height H changes gradually across the recessed part and the non-recessed part. The sheet material may comprise an obtuse angle face portion formed on a near part to a bottom of the recessed part which comprises a wide angle face portion formed on a near part to the non-recessed part. In a producing method of the sheet material, an embossing mold material comprises an embossing gradual changing part in which a depth D changes gradually across an embossing projected part and an embossing non-projected part. The embossing mold material is pressed in a situation where the embossing projected part and the embossing gradual changing part are abutting to a surface side of a cushion base material.

### CROSS-REFERENCE TO RELATED PATENT APPLICATIONS

This application is a U.S. National Phase Application under 35 U.S.C. § 371 of International Patent Application No. PCT/JP2018/035509, filed Sep. 25, 2018, and claims the benefit of priority to Japanese Patent Application No. 2017-240089 filed Dec. 14, 2017, all of which are incorporated herein by reference in their entirety. The International Application was published in Japanese on Jun. 20, 2019 as International Publication No. WO/2019/116674 under PCT Article 21(2).

### FIELD OF THE INVENTION

A present invention relates to a sheet material which comprises at least one recessed part and at least one non-recessed part formed on a surface side of a cushion base material, a producing method to produce the sheet material, and, an embossing mold material.

### BACKGROUND OF THE INVENTION

Hitherto, a producing method of a cover material, which a raw material sheet is pressurized to a shaped mold having a shaped recessed part while heating, which an embossing pattern is formed to a shape-imparting face of the raw material sheet in protruding state, is known (refer to Japanese Patent Application Laid Open No. 2017-165062).

In the producing method of the cover material, a laser working is applied to a mold raw material based on an engraving data adjusted with capturing an original image to computer, the shaped mold has the shaped recessed part formed corresponding to the original image, the producing method includes a preparation process stacking and placing the shaped mold and the raw material sheet formed by thermoplastic resin on an immobilized electrode stand, and a pressurizing process pressing out a heated movable electrode stand to the raw material sheet and pressurizing the raw material sheet to the shaped mold while supplying high frequency current between the immobilized electrode stand and a movable electrode stand, in the producing method the cover material is formed, in the pressurizing process, an embossing pattern in protruding state is exposed to the raw material sheet according to compressing a sheet face of the raw material sheet which is not right opposite to the shaped recessed part with a dimension of maximum depth or more of shaped recessed part, adhering closely the sheet face to an inner face of the shaped recessed part.

### Problem to be Solved

However, in the producing method of the cover material disclosed in Japanese Patent Application Laid Open No. 2017-165062, as shown in FIG. 1 of Japanese Patent Application Laid Open No. 2017-165062, only the embossing pattern having tight sharpness can be exposed, because any projected part of the embossing pattern stands about 90 degrees from a recessed face and so on, for clarifying of the embossing pattern.

Moreover, in the producing method of the cover material of Japanese Patent Application Laid Open No. 2017-165062, complication, deterioration of production efficiency and rise of production cost and so on are caused of the machine construction, according to those becoming essential that the engraving data adjusted by capturing the original image to computer, laser working machine to apply the mold raw material, the immobilized electrode stand stacking and placing the raw material sheet formed by thermoplastic resin, the movable electrode stand pressing out to the raw material sheet and being heated, and a machine to supply high frequency current between the immobilized electrode stand and the movable electrode stand and so on.

The present invention, in view of the problems like these, aims to provide a sheet material, a producing method of a sheet material, and, an embossing mold material which can realize “a gradation across at least one recessed part and at least one non-recessed part” and so on, according to comprising at least one gradual changing part in which a height, from a bottom of the recessed part, changes gradually across the recessed part and the non-recessed part et cetera.

### SUMMARY OF THE INVENTION

The sheet material 1 of the present invention is the 1st characterized by the following; the sheet material comprises at least one recessed part 3 and at least one non-recessed part 4 which are formed on a surface side of a cushion base material 2; the sheet material comprises at least one gradual changing part 5 in which a height H, from a bottom of the recessed part 3, changes gradually across the recessed part 3 and the non-recessed part 4.

The 2nd characteristic of the sheet material 1 of the present invention is, in addition to the above 1st characteristic, the sheet material comprises at least one obtuse angle face portion 6a which is formed on at least a part of a near part to the bottom of the recessed part 3 in the gradual changing part 5, an angle θa, between the obtuse angle face portion 6a and a bottom surface of the recessed part 3, is 160 degrees or more and less than 180 degrees, and/or, the sheet material comprises at least one wide angle face portion 6b which is formed on at least a part of a near part to a surface of the non-recessed part 4 in the gradual changing part 5, an angle θb, between the wide angle face portion 6b and the non-recessed part 4, is more than 180 degrees and 200 degrees or less.

The 3rd characteristic of the sheet material 1 of the present invention is, in addition to the above 1st or 2nd characteristics, the sheet material comprises at least one skin material 7 which is laminated on the surface side of the cushion base material 2; the recessed part 3 is formed according to recessing the skin material 7 and also the cushion base material 2.

The 4th characteristic of the sheet material 1 of the present invention is, in addition to the above 1st to 3rd characteristics, the skin material 7 is formed by a raw material of thermoplastic; the non-recessed part 4 is at least one portion not to degenerate the skin material 7.

The 5th characteristic of the sheet material 1 of the present invention is, in addition to the above 1st to 4th characteristics, the cushion base material 2 is a double raschel knitting fabric.

The 6th characteristic of the sheet material 1 of the present invention is, in addition to the above 1st to 5th characteristics, the sheet material comprises at least one main gradual changing part 8 which is provided in at least one part of the gradual changing part 5; the height H in the main gradual changing part 8 uniformly changes gradually across the recessed part 3 and the non-recessed part 4, and the main gradual changing part 8 comprises a gradual changing distance Z which is the longest distance from the bottom of the recessed part 3 to the non-recessed part 4 viewing in a plan-view, the main gradual changing part 8 comprises a main gradual changing direction L which is a direction of the gradual changing distance Z.

The 7th characteristic of the sheet material 1 of the present invention is, in addition to the above 6th characteristic, the sheet material comprises a plurality pieces of the gradual changing parts 5, in each which the main gradual changing part 8 is provided; the main gradual changing directions L, on the main gradual changing parts 8 of at least two pieces of the gradual changing parts 5, in the main gradual changing parts 8 of the plurality pieces of the gradual changing parts 5, are in approximately parallel mutually.

The 8th characteristic of the sheet material 1 of the present invention is, in addition to the above 6th or 7th characteristics, the main gradual changing direction L on the main gradual changing part 8 is curved.

Owing to the characteristics, unlike Japanese Patent Application Laid Open No. 2017-165062, as shown in FIGS. 2 to 7, it becomes gentle that between the recessed part 3 and the non-recessed part 4, and also, it becomes difficult to visually recognize or it becomes to not able to visually recognize at least one boundary between the gradual changing part 5 and the non-recessed part 4 (that is, it also can be said that the boundary is erased), it can realize suppressing sharpness of a part of the recessed part 3, and it can realize “a gradation across the recessed part 3 and the non-recessed part 4”, according to providing the gradual changing part 5 in which the height H, from the bottom 3a of the recessed part 3, changes gradually across the recessed part 3 and the non-recessed part 4.

Furthermore, the sheet material 1, which realizes the gradation across the recessed part 3 and the non-recessed part 4, also can be said “a inclined sheet material”, it also can be said what the gradation means that the recessed part 3 fades away by gradation.

And, “the height H, from the bottom 3a of the recessed part 3, changes gradually” in the present invention means that the height H becomes higher by gradation as it approaches from the bottom 3a of the recessed part 3 to the non-recessed part 4, and means that after the height H becoming higher by gradation, the height H becoming lower by gradation, and the height H again becoming higher by gradation while it reached the bottom 3a of the recessed part 3 to the non-recessed part 4 and so on, it does not include a portion (a bending portion) in which the height H changes rapidly.

And, it becomes more difficult to visually recognize or it becomes to not able to visually recognize the boundary between the recessed part 3 and the gradual changing part 5, and/or the boundary between the non-recessed part 4 and the gradual changing part 5, “the gradation across the recessed part 3 and the non-recessed part 4” becomes smoother, according to comprising the obtuse angle face portion 6a which is formed on a near part to the bottom of the recessed part 3 in the gradual changing part 5, the angle θa, between the obtuse angle face portion 6a and the bottom surface of the recessed part 3, is 160 degrees or more and less than 180 degrees, comprising the wide angle face portion 6b which is formed on a near part to the surface of the non-recessed part 4 in the gradual changing part 5, the angle θb, between the wide angle face portion 6b and the non-recessed part 4, is more than 180 degrees and 200 degrees or less.

Moreover, even if it uses the same raw material as the cushion base material 2, at least one surface property (color, raw material et cetera) becomes variously selectable with only altering the skin material 7, and also, it can realize “the gradation across the recessed part 3 and the non-recessed part 4” against the skin material 7, according to forming the recessed part 3 to make the skin material 7 and also the cushion base material 2 which is laminated on the surface side of the cushion base material 2.

Then, it can realize “the gradation from the recessed part 3”, and also, it retains at least one surface property (for example, fluff, touch feeling et cetera) of non-recessed part 4 in the skin material 7, according to forming the skin material 7 by raw material of thermoplastic, making the non-recessed part 4 the portion not to degenerate the skin material 7.

Furthermore, “degenerating of the skin material 7” in the present invention means that at least one surface property (gloss, ruggedness and so on) of the skin material 7 changes according to melting, softening the skin material 7 by heat et cetera.

And, it can attain further improvement of cushioning property as the sheet material 1, reduction of the bottom reach-feeling, improvement of durability, according to making the cushion base material 2 the double raschel knitting fabric.

Moreover, it can realize “the gradation along a predetermined direction (one direction, or, a plurality of directions) across the recessed part 3 and the non-recessed part 4” et cetera, according to providing the main gradual changing part 8 in which the height H uniformly changes gradually, which comprises the main gradual changing direction L which the gradual changing distance Z is the longest, the main gradual changing directions L, on at least two pieces of the main gradual changing parts 8, being in approximately parallel mutually, and the main gradual changing direction L of the main gradual changing part 8 being curved.

The producing method of the sheet material of the present invention is the 1st characterized by the following; the producing method comprises an embossing process E pressing at least one embossing mold material 13, which at least one embossing projected part 11 and at least one embossing non-projected part 12 are formed, to a surface side of at least one cushion base material 2; the producing method is a producing method producing at least one sheet material which at least one recessed part 3 and at least one non-recessed part 4 are formed on a surface side of the cushion base material 2; the embossing mold material 13 comprises at least one embossing gradual changing part 14 in which a depth D, from a top of the embossing projected part 11, changes gradually across the embossing projected part 11 and the embossing non-projected part 12; in the embossing process E, the embossing mold material 13 is pressed in a situation that the embossing projected part 11 and the embossing gradual changing part 14 are abutting to the surface side of the cushion base material 2.

Owing to the characteristic, as shown in FIGS. 2 to 7, it becomes gentle that between the recessed part 3 and the non-recessed part 4, it becomes difficult to visually recognize or it becomes to not able to visually recognize the boundary between the gradual changing part 5 and the non-recessed part 4, it can realize “the gradation across the recessed part 3 and the non-recessed part 4”, according to providing the embossing gradual changing part 14 in which the depth D, from the top 11a of the embossing projected part 11, changes gradually across the embossing projected part 11 and the embossing non-projected part 12, and pressing the embossing mold material 13 in a situation that the embossing projected part 11 and the embossing gradual changing part 14 are abutting to the surface side of the cushion base material 2.

At the same time of this, unlike Japanese Patent Application Laid Open No. 2017-165062, those become unnecessary that the engraving data, the laser working machine, the immobilized electrode stand and the movable electrode stand and so on, it can attain simplification of machine construction, improvement of production efficiency, reduction of production cost and so on.

Furthermore, the producing method of the sheet material 1, which realizes the gradation across the recessed part 3 and the non-recessed part 4, also can be said “a producing method of a inclined sheet material”.

The embossing mold material 13 of the present invention is the 1st characterized by the following; the embossing mold material comprises at least one embossing projected part 11 and at least one embossing non-projected part 12 which are formed on the embossing mold material; the embossing mold material comprises at least one embossing gradual changing part 14 in which a depth D, from a top of the embossing projected part 11, changes gradually across the embossing projected part 11 and the embossing non-projected part 12.

Owing to the characteristic, as shown in FIGS. 2 to 7, it becomes gentle that between the recessed part 3 and the non-recessed part 4, it becomes difficult to visually recognize or it becomes to not able to visually recognize the boundary between the gradual changing part 5 and the non-recessed part 4, it can realize “the gradation across the recessed part 3 and the non-recessed part 4” in the sheet material 1, according to using embossing mold material 13 which provides the embossing gradual changing part 14 in which the depth D, from the top 11a of the embossing projected part 11, changes gradually across the embossing projected part 11 and the embossing non-projected part 12.

At the same time of this, unlike Japanese Patent Application Laid Open No. 2017-165062, those become unnecessary that the engraving data, the laser working machine, the immobilized electrode stand and the movable electrode stand and so on, it can attain simplification of machine construction, improvement of production efficiency, reduction of production cost and so on.

Furthermore, the embossing mold material 13, which realizes the gradation across the recessed part 3 and the non-recessed part 4, also can be said “an embossing mold material to produce a inclined sheet material”.

### Effect of the Invention

The sheet material of the present invention can realize “the gradation across the recessed part and the non-recessed part” and so on, according to comprising at least one gradual changing part in which the height, from the bottom of the recessed part, changes gradually across the recessed part and the non-recessed part.

And, the producing method of the sheet material of the present invention can realize “the gradation across the recessed part and the non-recessed part” and so on, according to providing at least one embossing gradual changing part in which the depth, from the top of the embossing projected part, changes gradually across the embossing projected part and the embossing non-projected part, and pressing the embossing mold material in a situation that the embossing projected part and the embossing gradual changing part are abutting to the surface side of the cushion base material.

Moreover, the embossing mold material of the present invention can realize “the gradation across the recessed part and the non-recessed part” and so on, according to providing at least one embossing gradual changing part in which the depth, from the top of the embossing projected part, changes gradually across the embossing projected part and the embossing non-projected part.

### BRIEF DESCRIPTION OF THE DRAWINGS

FIGS. 1A-1D show sectional-views of the sheet material of the present invention. FIG. 1A shows the 1st embodiment of the present invention, FIG. 1B shows the 2nd embodiment of the present invention, FIG. 1C shows the 3rd embodiment of the present invention, FIG. 1D shows the 4th embodiment of the present invention.

FIG. 2 shows a substitute photo for figure of an example 1 of the sheet material viewing in a plan-view.

FIG. 3 shows a substitute photo for figure of an example 2 of the sheet material viewing in a plan-view.

FIG. 4 shows a substitute photo for figure of an example 3 of the sheet material viewing in a plan-view.

FIG. 5 shows a substitute photo for figure of an example 4 of the sheet material viewing in a plan-view.

FIG. 6 shows a substitute photo for figure of an example 5 of the sheet material viewing in a plan-view.

FIG. 7 shows a substitute photo for figure of an example 6 of the sheet material viewing in a plan-view.

FIGS. 8A and 8B show sectional-views of the producing method of the sheet material and of the embossing mold material of the 1st embodiment of the present invention, and FIG. 8A shows a situation of before embossing process, FIG. 8B shows a situation of during embossing process.

FIGS. 9A and 9B show sectional-views of the producing method of the sheet material and of the embossing mold material of the 2nd embodiment of the present invention, and FIG. 9A shows a situation of before embossing process, FIG. 9B shows a situation of during embossing process.

### DETAILED DESCRIPTION OF THE INVENTION

### <The Whole Constitution of the Sheet Material 1>

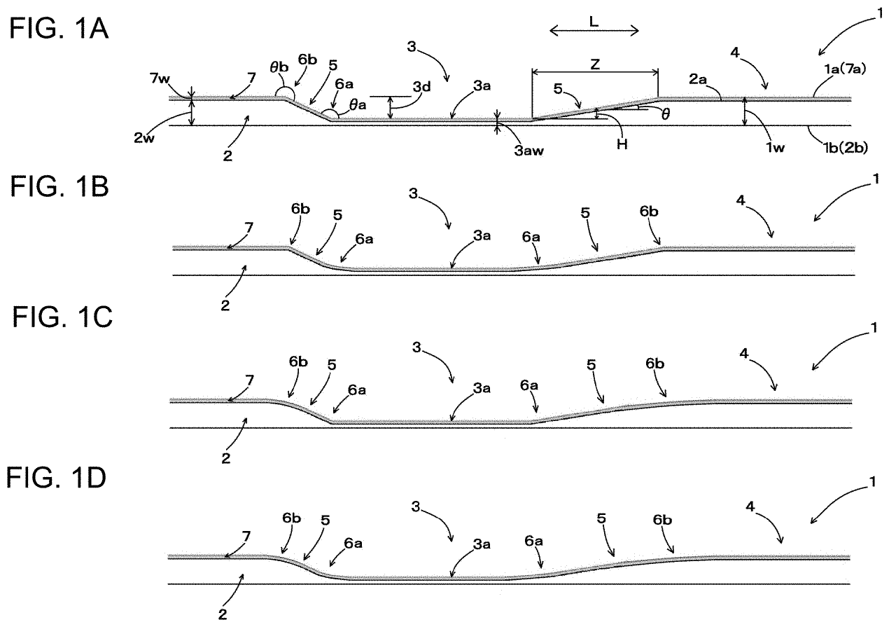

The embodiments of the present invention are explained to refer to the figures below. FIGS. 1A to 7 show the sheet material 1 of the present invention, this sheet material 1 is a sheet-like object which the recessed part 3 and the non-recessed part 4 are formed on the surface 2a side of the cushion base material 2 (it also can be said that the surface 2a of the cushion base material 2 side is a surface 1a side of the sheet material 1).

The sheet material 1 comprises the gradual changing part 5 described later across the recessed part 3 and the non-recessed part 4.

And, the gradual changing part 5 in the sheet material 1 may comprise the obtuse angle face portion 6a, and/or the wide angle face portion 6b described later. Moreover, the sheet material 1 may comprise the skin material 7 which is laminated on the surface 2a side of the cushion base material 2 (the surface 1a side of the sheet material 1).

At this point, it also can be said that “the surface 1a” of the sheet material 1 is a face of a side to expose, when using the sheet material 1 as an interior material, such as an ornament (a door trim and so on), an arm rest, an instrument panel, a seat cover which covers a seat (chair) and so on in automobile et cetera.

Inversely, it also can be said that “a back face 1b” of the sheet material 1 is a face of a side not to expose when using the sheet material 1 as the ornament, the arm rest, the instrument panel and so on.

A thickness 1w of the sheet material 1 may be any value, for example, may be 1 mm or more and 100 mm or less, preferably 1 mm or more 50 mm or less, more preferably 2 mm or more 40 mm or less (2 mm, 3 mm, 4 mm, 5 mm, 10 mm, 30 mm and so on). Furthermore, in the case that the thickness 1w of the sheet material 1 is 2 mm and so on (in the case that the sheet material 1 is thin), it also can be said that the sheet material 1 as the ornament (the door trim and so on) becomes for sporty.

In the thickness 1w of the sheet material 1, a thickness from the bottom 3a of the recessed part 3 to the back face 1b of the sheet material 1, obviously, becomes a value which subtracted a depth (a depth from the surface 1a of the sheet material 1 to the bottom 3a of the recessed part 3) 3d of the recessed part 3 from the thickness 1w of the sheet material 1.

Furthermore, in the case that the sheet material 1 is thick (in the case that the thickness 1w is a predetermined value (for example, 30 mm and so on) or more), it also can be said that the sheet material 1 is approximately rectangular parallelepiped body-like shape.

Below, we describe the cushion base material 2 which is included in the sheet material 1.

### <The Cushion Base Material 2>

As shown in FIGS. 1A to 7, the cushion base material 2 is material which becomes a base material of the above-mentioned sheet material 1, which comprises cushioning property (buffer property, flexibility), and on the surface 2a side the cushion base material 2, the recessed part 3 and the non-recessed part 4 are formed.

Furthermore, it also can be said that “the surface 2a” of the cushion base material 2 is a face of a side to expose when using if the skin material 7 described later is not laminated, a face of a near side to the side to expose when using if the skin material 7 described later is laminated, in the case of using the sheet material 1 as the ornament (the door trim), arm rest, instrument panel and so on in automobile et cetera.

Inversely, it also can be said that “a back face 2b” of the cushion base material 2 is a face of a side not to expose, or a face of a near side to the side not to expose when using the sheet material 1 as the ornament, the arm rest, the instrument panel and so on.

Moreover, “the surface 2a side” of the cushion base material 2 also means a side of the above-mentioned surface 2a of the cushion base material 2 in addition to a near side to a surface 7a of the skin material 7 to expose when using if the skin material 7 described later is laminated, moreover, means a side of the surface 7a itself of the skin material 7.

A thickness 2w of the cushion base material 2 may be any value, for example, may be 1 mm or more and 100 mm or less, preferably 1 mm or more 50 mm or less, more preferably 2 mm or more 40 mm or less (1.5 mm, 2 mm, 3 mm, 3.5 mm, 4 mm, 5 mm, 10 mm, 30 mm and so on).

A constitution, a raw material of the cushion base material 2 also are not particularly limited, for example, may be a knitting fabric (knit fabric) and so on, such as double raschel knitting fabric (spacer raschel knitting fabric), which a front warp knitting fabric and a back warp knitting fabric are connected with connection threads, and which comprises a space between the front warp knitting fabric and the back warp knitting fabric, may be a weaving fabric (woven fabric) and so on, such as a double weave, multiple weave and so on of double or more, may be cloth including the knitting fabric (knit fabric), the weaving fabric (woven fabric).

A raw material of fibers which is included (knitted, woven et cetera) in the cloth also is not particularly limited, for example, may be synthetic fibers which are raw material of thermoplastic, such as polyester fibers such as polyethylene terephthalate (PET), polytrimethylene terephthalate (PTT), polybutylene terephthalate (PBT) et cetera, nylon (polyamide) fibers, polyolefin-based fibers such as polyethylene (PE), polypropylene (PP) et cetera, rayon fibers, cupra fibers, acetate fibers, acrylic fibers whose main component is polyacrylonitrile (PAN), polyvinyl alcohol (PVA) fibers (vinylon fibers), polyurethane (PU) fibers and so on, besides, may be a glass fibers, wool, silk and so on, these may be alone or in combination use.

And, a fineness of the fibers which is included (knitted, woven et cetera) in the cloth also may be any value, for example, a total fineness of the fibers may be 20 dtex or more 3000 dtex or less.

Besides, the constitution, the raw material of the cushion base material 2 also may be, for example, a foamed synthetic resin (synthetic resin foam), such as a polyurethane foam (PUF), a polystyrene foam (PSF), a polyethylene foam (PEF), a polypropylene foam (PPF) et cetera.

Moreover, the constitution, the raw material of the cushion base material 2 also may be, for example, a nonwoven fabric of synthetic resin, the fibers which is included in the nonwoven fabric may be the synthetic fibers, such as the polyester fibers such as polyethylene terephthalate (PET) et cetera, the nylon (polyamide) fibers, the polyolefin-based fibers such as polyethylene (PE), polypropylene (PP) et cetera, the rayon fibers, the cupra fibers, the acetate fibers, the acrylic fibers whose main component is polyacrylonitrile (PAN), the polyvinyl alcohol (PVA) fibers (vinylon fibers), the polyurethane (PU) fibers and so on, besides, may be the glass fibers, wool, cotton, silk and so on, these may be alone or in combination use.

Besides these, the constitution, the raw material of the cushion base material 2 also may be, for example, a synthetic leather, the synthetic leather may use the cloth (fabric), such as the woven fabric (weaving fabric), the knit fabric (knitting fabric), the nonwoven fabric as a base material, may coat and/or impregnate synthetic resin with the base material. Furthermore, in the synthetic leather, a synthetic leather, which the base material is a nonwoven fabric, which is synthetic resin is impregnated, also is said that an artificial leather.

Moreover other than that, the constitution, the raw material of the cushion base material 2 also may be, for example, a sheet-like object, such as a film and so on, a raw material of the sheet-like object may be synthetic resin and so on, such as polyvinyl chloride (PVC) resin, polyester resin such as polyethylene terephthalate (PET), polytrimethylene terephthalate (PTT), polybutylene terephthalate (PBT) et cetera, polyamide (PA) resin, polyurethane (PU) resin and so on, these may be alone or in combination use. And, if the cushion base material 2 is the sheet-like object, such as the film and so on, an external appearance (the surface 7a) of the cushion base material 2 may be genuine leather-like (genuine leathery, natural leathery).

Besides, the constitution, the raw material of the cushion base material 2 also may be, for example, the genuine leather (natural leather) itself and so on.

### <The Recessed Part 3>

As shown in FIGS. 1A to 7, the recessed part 3 is recess formed on the surface (surface 2a) side of the cushion base material 2 (if the skin material 7 as mentioned below is laminated, the surface 7a of the skin material 7).

The recessed part 3 comprises the bottom 3a.

Only one piece of the recessed part 3 may be formed against one piece of cushion base material 2, a plurality pieces of the recessed parts 3 may be formed against one piece of cushion base material 2.

A plan-view shape of the recessed part 3 is not particularly limited, for example, may be approximately belt-like, approximately streak-like, approximately line-like shape and so on, and may be zigzag-like shape, dotted line-like shape, approximately X-shape, approximately circular shape, curved line-like shape and the like, approximately triangle, approximately regular pentagon, approximately regular hexagon, approximately square, approximately circular shape (approximately complete circle) and so on.

And, the plan-view shape of the recessed part 3 may be, for example, approximately rectangle (rectangle), approximately elliptical, approximately rhombus and so on, may comprise a longer direction and/or a shorter direction.

It also can be said that the depth 3d of the recessed part 3 is a depth from the surface 1a of the sheet material 1 (or, the surface 2a of the cushion base material 2, the surface 7a of the skin material 7) to the bottom 3a of the recessed part 3, inversely, the height H from the bottom 3a of the recessed part 3 to the surface 1a of the sheet material 1.

The value of the depth 3d is not particularly limited may be, for example, may be 0.1 mm or more 20 mm or less, preferably 0.3 mm or more 10 mm or less, more preferably 0.5 mm or more 7 mm or less (0.028 mm, 0.056 mm, 0.084 mm, 0.1 mm, 0.112 mm, 0.140 mm, 0.168 mm, 0.196 mm, 0.2 mm, 0.224 mm, 0.25 mm, 0.252 mm, 0.280 mm, 0.3 mm, 0.308 mm, 0.336 mm, 0.5 mm, 0.75 mm, 1.0 mm, 3.5 mm, 4.0 mm, 4.5 mm, 5.0 mm and so on).

In the case that such recessed parts 3 are, as mentioned above, the plurality pieces of the recessed parts 3 may be formed repeatedly arranging approximately along the longer direction and the shorter direction, as each of the longer directions become in approximately parallel mutually, and each of the shorter directions become in approximately parallel mutually.

Other than this, the plurality pieces of the recessed parts 3 may be arranged randomly with ignoring whether each of the longer directions and/or the shorter directions are in approximately parallel mutually.

### <The Bottom 3a of the Recessed Part 3>

As shown in FIGS. 1A to 7, the bottom (bottom face) 3a of the recessed part 3 is located on the lowermost position (on the nearest position to the back face 1b of the sheet material 1 (the back face 2b of the cushion base material 2) in the recessed part 3, it also can be said that the bottom 3a is an adjacent portion to the gradual changing part 5 described later.

The bottom 3a of the recessed part 3 may be an approximately flat face (approximately plane face), or may be a curved face (curve face).

The plan-view shape of the bottom 3a of the recessed part 3 also is not particularly limited, for example, approximately belt-like, approximately streak-like, approximately line-like, zigzag-like shape, dotted line-like shape, approximately X-shape, approximately circular shape, curved line-like shape, approximately triangle, approximately regular pentagon, approximately regular hexagon, approximately square, approximately circular shape (approximately complete circle), approximately rectangle (rectangle), approximately elliptical, approximately rhombus and so on, may comprise a longer direction and/or a shorter direction.

Besides, the plan-view shape of the bottom 3a of the recessed part 3 may be approximately similar and reducing shape to the plan-view shape of the above-mentioned recessed part 3, inversely, not need to be approximately similar to the plan-view shape of the above-mentioned recessed part 3 (for example, though the plan-view shape of the recessed part 3 is approximately rectangle, the plan-view shape of the bottom 3a is approximately elliptical and so on).

A thickness 3aw of the bottom 3a of the recessed part 3 is a thickness from the bottom 3a of the recessed part 3 to the back face 1b of the sheet material 1, it also can be said that the thickness 3aw is a value which subtracted the depth 3d of the recessed part 3 from the thickness 1w of the sheet material 1. The thickness 3aw also is not particularly limited, for example, may be 0.1 mm or more 2.0 mm or less, preferably 0.2 mm or more 1.5 mm or less, more preferably 0.3 mm or more 1.0 mm or less (0.5 mm, 0.8 mm and so on).

Some of the mentioned recessed part 3 may join, branch, mutually intersect other recessed part 3, other gradual changing part 5 described later, other main gradual changing part 8 in the middle (that is, the recessed part 3 may comprise a joining portion, a branching portion, intersecting portion). And, one piece of the recessed part 3 may comprise a plurality pieces of the joining portion, the branching portion, the intersecting portion.

### <The Non-Recessed Part 4>

As shown in FIGS. 1A to 7, the non-recessed part 4 is a portion not to be the recessed part 3, it also can be said that the non-recessed part 4 is a portion surrounding a periphery of the recessed part 3. In the case that the plurality pieces of the recessed parts 3 are formed, the non-recessed part 4 is a clearance which exists between adjacent two pieces of the recessed parts 3, it also can be said that the non-recessed part 4 is a portion except the recessed parts 3 from the surface 1a of the sheet material 1.

And, in the case that after once recessing a predetermined range (a wide range to some extent) in the surface 2a of the cushion base material 2, and more recessing a part of the predetermined range, the more recessing portion is the recessed part 3 and so on, it also can be said that other portion than the more recessing portion in the predetermined range becomes the non-recessed part 4.

The plan-view shape of the non-recessed part 4 becomes a shape extracting one piece or the plurality pieces of the recessed parts 3 from the surface 1a of the sheet material 1 (the surface 2a of the cushion base material 2, the surface 7a of the skin material 7).

In the case that the skin material 7 is formed by raw material of thermoplastic, the non-recessed part 4 may be a portion (a non-degenerated portion) 7′ which the skin material 7 does not degenerate. Furthermore, we describe the non-degenerated portion 7′ in detail later.

And, in the case that the recessed part 3 is formed by the producing method (embossing process E) described later of the sheet material, the embossing mold material 13, it also can be said that the non-recessed part 4 is a portion which the embossing mold material 13 described later does not be pressed (as it were, non-embossing portion) in the cushion base material 2, the skin material 7.

### <The Gradual Changing Part 5>

As shown in FIGS. 1A to 7, the gradual changing part 5 is a portion in which the height H from the bottom 3a of the recessed part 3 changes gradually, it also can be said that the gradual changing part 5 is a inclined face (a gradual changing face) which is provided across from the recessed part 3 to the non-recessed part 4 (across the recessed part 3 and the non-recessed part 4).

At this point, “the height H from the bottom 3a of the recessed part 3 changes gradually”, as mentioned above, means that the height H becomes higher by gradation as it approaches from the bottom 3a of the recessed part 3 to the non-recessed part 4, and means that after the height H becoming higher by gradation, the height H becoming lower by gradation, and the height H again becoming higher by gradation while it reached the bottom 3a of the recessed part 3 to the non-recessed part 4 and so on, it does not include a portion (a bending portion) in which the height H changes rapidly (in other words, a side sectional-view shape of the gradual changing part 5 does not comprise a bending point (a point which a tangential line is not determined uniquely), and, the gradual changing part 5 does not include a portion which intersects at approximately 90 degrees against the bottom 3a of the recessed part 3.

Furthermore, not only the height H in the gradual changing part 5 constantly changes while it reached the bottom 3a of the recessed part 3 to the non-recessed part 4, the gradual changing part 5 may comprise a portion which a change amount of the height H is of 0 (zero), that is, the gradual changing part 5 may include an approximately flat portion (in the approximately flat portion, the tangential line is determined uniquely) approximately along a horizontal direction (the surface 1a of the sheet material 1, the bottom 3a of the recessed part 3 and so on).

And, the gradual changing part 5, as mentioned above, is provided across from the recessed part 3 to the non-recessed part 4, this is, the gradual changing part 5 includes four embodiments of <1> the 1st embodiment (refer to FIG. 1 A) bending at both a boundary between the bottom 3a of the recessed part 3 and the gradual changing part 5, and a boundary between the non-recessed part 4 and the gradual changing part 5, <2> the 2nd embodiment (refer to FIG. 1 B) not bending at the boundary between the bottom 3a of the recessed part 3 and the gradual changing part 5, but bending at the boundary between the non-recessed part 4 and the gradual changing part 5, <3> the 3rd embodiment (refer to FIG. 1 C) bending at the boundary between the bottom 3a of the recessed part 3 and the gradual changing part 5, but not bending at the boundary between the non-recessed part 4 and the gradual changing part 5, <4> the 4th embodiment (refer to FIG. 1 D) not bending at both the boundary between the bottom 3a of the recessed part 3 and the gradual changing part 5, and the boundary between the non-recessed part 4 and the gradual changing part 5.

At this point, it also can be said that not bending at each of the boundaries means that each of the boundaries is rounded viewing in a side sectional-view.

Besides, the gradual changing part 5 may comprise the obtuse angle face portion 6a described later, which is formed on the near part to the bottom 3a of the recessed part 3, may comprise the wide angle face portion 6b described later, which is formed on the near part to the non-recessed part 4, both the obtuse angle face portion 6a and the wide angle face portion 6b may be formed, only either one of the obtuse angle face portion 6a and the wide angle face portion 6b may be formed, both the obtuse angle face portion 6a and the wide angle face portion 6b don't have to be formed.

Furthermore, in the case that the gradual changing part 5 comprises the obtuse angle face portion 6a and/or the wide angle face portion 6, after we describe, in the first place, the obtuse angle face portion 6a and/or the wide angle face portion 6b, we describe whether or not it bends at the boundary between the bottom 3a of the recessed part 3 and the gradual changing part 5, and/or the boundary between the non-recessed part 4 and the gradual changing part 5 in detail.

The gradual changing part 5 may be a uniform approximately plane face from the bottom 3a of the recessed part 3 to the non-recessed part 4, besides, the gradual changing part 5 may be a curved face (curve face).

At this point, in the case that the gradual changing part 5 is the uniform approximately plane face, an angle between the gradual changing part 5 and the horizontal direction t is a gradual changing angle θ.

Furthermore, “the horizontal direction” in the gradual changing angle θ between the gradual changing part 5, which is the uniform approximately plane face, and the horizontal direction means, in the case that a spot is placed in approximately horizontal, literal approximately horizontal direction, in the case that a spot, which is not placed in approximately horizontal, occurs according to the sheet material 1 using the ornament, the arm rest, instrument panel and so on, “the horizontal direction” means a direction approximately along the surface 1a of the sheet material 1 (the surface 2a of the cushion base material 2, or the surface 7a of the skin material 7), if the bottom 3a of the recessed part 3 is the approximately plane face, “the horizontal direction” means a direction approximately along the bottom 3a.

And, if the gradual changing angle θ is more than 0 degrees and less than 90 degrees, a value of the gradual changing angle θ is not particularly limited, for example, may be more than 0 degrees and 45 degrees or less, preferably more than 0 degrees and 20 degrees or less, more preferably more than 0 degrees and 10 degrees or less (0.3 degrees, 0.6 degrees, 1.0 degrees, 1.1 degrees, 1.4 degrees, 1.6 degrees, 3.2 degrees, 4.8 degrees, 5.7 degrees, 6.3 degrees, 7.9 degrees, 9.5 degrees, 11.0 degrees, 11.3 degrees, 12.5 degrees, 14.0 degrees, 15.5 degrees, 17.0 degrees, 18.4 degrees, 26.6 degrees and so on).

On the other hand, in the case that the gradual changing part 5 is the curve face, between the bottom 3a of the recessed part 3 and the non-recessed part 4, the gradual changing part 5 may comprise a portion (a projected curve face portion) to swell upward (toward the non-recessed part 4 side), inversely, may comprise a portion (a recessed curve face portion) to swell downward (toward the recessed part 3 side), may comprise both the projected curve face portion and the recessed curve face portion and so on, if the height H from the bottom 3a of the recessed part 3 changes gradually, a swelling rate toward a vertical direction may change.

We describe the side sectional-view shape of the gradual changing part 5. In the case that the gradual changing part 5 is the uniform approximately plane face, the side sectional-view shape becomes an approximately straight line-like shape, if the gradual changing part 5 is the curve face, the side sectional-view shape becomes a curve-like shape.

In more detail, in the case that the gradual changing part 5 comprises the projected curve face portion, the side sectional-view shape becomes to comprise a curve portion projecting upward, in the case that the gradual changing part 5 comprises the recessed curve face portion, the side sectional-view shape becomes to comprise a curve portion projecting downward, in the case that the gradual changing part 5 comprises the projected curve face portion and the recessed curve face portion, the side sectional-view shape becomes to comprise the curve portion projecting upward and the curve portion projecting downward.

A plane position (a position when viewed the surface 1a side of the sheet material 1 from above), which the gradual changing part 5 is provided, also is not particularly limited, between the recessed part 3 and the non-recessed part 4 surrounding the periphery of the recessed part 3, the gradual changing part 5 may be provided on only a part of periphery of the recessed part 3, the gradual changing part 5 may be provided to surround all periphery of the recessed part 3.

Furthermore, viewing in a plan-view of the gradual changing part 5 which is the uniform approximately plane face, the gradual changing distance Z is a distance, which the height H in the main gradual changing part 8 uniformly changes gradually across the recessed part 3 and the non-recessed part 4, and which is the longest distance from the bottom of the recessed part 3 to the non-recessed part 4, the main gradual changing direction L is a direction of the gradual changing distance Z.

And, in each of the gradual changing part 5, a portion, which comprise the main gradual changing direction L, we describe the main gradual changing part 8 in detail later.

Furthermore, the value of the gradual changing distance Z is not particularly limited, for example, may be 0.1 mm or more and 300 mm or less, preferably 0.2 mm or more and 200 mm or less, more preferably 0.3 mm or more and 100 mm or less (1 mm, 3 mm, 4 mm, 30 mm, 40 mm, 60 mm, 90 mm, 100 mm, 180 mm, 220 mm and so on).

And, it also can be said that other direction than the main gradual changing direction L is a secondary gradual changing direction, though the gradual changing distance Z of the secondary gradual changing direction is shorter than the gradual changing distance Z of the main gradual changing direction L, the secondary gradual changing direction means a direction in which the height H uniformly changes gradually across from the recessed part 3 to the non-recessed part 4.

One piece of the gradual changing part 5 may comprise both the main gradual changing direction L and the secondary gradual changing direction (for example, the plan-view shape of the recessed part 3, the gradual changing part 5 is approximately belt-like and so on).

Besides, in the case that the gradual changing distances Z from the bottom 3a of the recessed part 3 to the non-recessed part 4 surrounding the recessed part 3 are almost the same in any direction (in the case that an inner shape and an outer shape of the plan-view shape of the gradual changing part 5 surrounding the bottom 3a of the recessed part 3 are approximately similar to the plan-view shape of the bottom 3a and so on), because any direction becomes the main gradual changing direction L (or secondary gradual changing direction), it also can be said that one piece of the gradual changing part 5 (refer to the examples 3 to 6 described later) becomes to comprise only the main gradual changing direction L (or, it can't be determined whether any direction is the main gradual changing direction L or the secondary gradual changing direction).

The number of the gradual changing part 5 may be any value in one piece of the recessed part 3, for example, the number of the gradual changing part 5 may be one piece or two pieces, three pieces or more.

Furthermore, in the case that the gradual changing part 5 is provided on only a part of the periphery of the recessed part 3, a portion, in which the height H from the bottom 3a of the recessed part 3 does not change gradually in other portion than the gradual changing part 5, is a recessed inner periphery 3b.

The recessed inner periphery 3b, if the height H from the bottom 3a of the recessed part 3 does not change gradually, may be any constitution, for example, it also can be said that the recessed inner periphery 3b includes a portion in which the height H rapidly changes between from the bottom 3a of the recessed part 3 to the non-recessed part 4 (between from the boundary between bottom 3a of the recessed part 3 and the gradual changing part 5, to the boundary between the non-recessed part 4 and the gradual changing part 5).

A specific example of the recessed inner periphery 3b of the gradual changing part 5 may directly stand at about 90 degrees from the bottom 3a of the recessed part 3, and reach the non-recessed part 4. Furthermore, a portion standing at about 90 degrees in which the height H does not change gradually, it can be said that the height H rapidly changes.

Besides, the recessed inner periphery 3b comprises a portion standing at about 90 degrees against the bottom 3a of the recessed part 3, the recessed inner periphery 3b may comprise a portion (a rounded portion) in which the height H changes by gradation, in a near portion to the bottom 3a of the recessed part 3, a near portion to the non-recessed part 4 and so on.

The inner shape (a shape which the boundary between the bottom 3a of the recessed part 3 and the gradual changing part 5 draws) and/or the outer shape (a shape which the boundary between the non-recessed part 4 and the gradual changing part 5 draws) of the plan-view shape of the gradual changing part 5 also are not particularly limited, for example, may be approximately belt-like, approximately streak-like, approximately line-like, zigzag-like shape, dotted line-like shape, approximately X-shape, approximately circular shape, curved line-like shape, approximately triangle, approximately regular pentagon, approximately regular hexagon, approximately square, approximately circular shape (approximately complete circle), approximately rectangle (rectangle), approximately elliptical, approximately rhombus and so on, may comprise a longer direction and/or a shorter direction.

Besides, the inner shape of the plan-view shape of the gradual changing part 5 becomes the same shape as the plan-view shape of the above-mentioned recessed part 3, and the outer shape becomes the same shape as the plan-view shape of the above-mentioned bottom 3a.

It can be said that a size of the gradual changing part 5 viewing in a plan-view is a size which subtracted a size of the bottom 3a from a size of the above-mentioned recessed part 3.

Some of the mentioned gradual changing part 5 may join, branch, mutually intersect other gradual changing part 5, the above-mentioned recessed part 3, and/or the main gradual changing part 8 in the middle (that is, the gradual changing part 5 may comprise a joining portion, a branching portion, an intersecting portion). And, one piece of the gradual changing part 5 may comprise the plurality pieces of the joining portion, the branching portion, the intersecting portion.

### <The Obtuse Angle Face Portion 6a, the Angle (Recessed Obtuse Angle) θa Between the Obtuse Angle Face Portion 6a and the Bottom 3a of the Recessed Part 3>

As shown in FIGS. 1A to 7, the obtuse angle face portion 6a may be formed on a near part to the bottom 3a of the recessed part 3 in the above-mentioned gradual changing part 5, the angle between the obtuse angle face portion 6a and the bottom 3a surface of the recessed part 3 (the recessed obtuse angle) θa is 160 degrees or more and less than 180 degrees.

At this point, “the obtuse angle face portion 6a is formed on a near part to the bottom 3a of the recessed part 3 in the above-mentioned gradual changing part 5” means that a portion between from the boundary between the bottom 3a of the recessed part 3 and the gradual changing part 5, to a position separated by a predetermined distance toward the non-recessed part 4 side from the boundary between the bottom 3a of the recessed part 3 and the gradual changing part 5, is the obtuse angle face portion 6a.

Furthermore, the recessed obtuse angle θa may be preferably 170 degrees or more and less than 180 degrees, more preferably 175 degrees or more and less than 180 degrees.

It also can be said that the recessed obtuse angle θa is 160 degrees or more and less than 180 degrees means that, in other words, an angle between the obtuse angle face portion 6a and the horizontal direction is more than 0 degrees and 20 degrees or less, preferably more than 0 degrees be and 10 degrees or less, more preferably more than 0 degrees and 5 degrees or less.

Furthermore, the meaning of “the horizontal direction” in the angle between the obtuse angle face portion 6a and the horizontal direction is also same as the meaning of “the horizontal direction” in the gradual changing angle θ between the above-mentioned gradual changing part 5 and the horizontal direction.

And, the recessed obtuse angle θa may be less than the above-mentioned gradual changing angle θ, in this case, the recessed obtuse angle θa is less than the above-mentioned gradual changing angle θ means that the angle against the horizontal direction becomes less as it approaches the bottom 3a of the recessed part 3 in the gradual changing part 5 (a slope becomes gentle).

The obtuse angle face portion 6a may be a uniform approximately flat face (an approximately plane face), the obtuse angle face portion 6a may be a curved face (curve face), such as a face (a face to project upward) to swell upward (toward the non-recessed part 4 side), inversely, a face (a face to project downward) to swell downward (toward the recessed part 3 side) and so on.

Furthermore, in the case that the obtuse angle face portion 6a is the curve face to swell downward, it becomes difficult to rapidly change the height H (it becomes difficult to bend) at the boundary between the obtuse angle face portion 6a and the bottom 3a of the recessed part 3, it also can be said that it becomes difficult to visually recognize the boundary between the obtuse angle face portion 6a and the bottom 3a of the recessed part 3.

And, it also can be said that it becomes difficult to visually recognize the boundary between the obtuse angle face portion 6a and the bottom 3a of the recessed part 3, as the above-mentioned recessed obtuse angle θa gets closer to 180 degrees (the angle between the above-mentioned obtuse angle face portion 6a and the horizontal direction gets closer to 0 degrees, that is, as the obtuse angle face portion 6a inclines gentler across from the gradual changing part 5 to the bottom 3a of the recessed part 3).

<The Wide Angle Face Portion 6b, the Projected Wide Angle θb>

As shown in FIGS. 1A to 7, the wide angle face portion 6b may be formed on a near part to the non-recessed part 4 in the above-mentioned gradual changing part 5, the angle between the wide angle face portion 6b and the surface of the non-recessed part 4 (the projected wide angle) θa is more than 180 degrees and 200 degrees or less.

At this point, “the wide angle face portion 6b is formed on a near part to the non-recessed part 4 in the above-mentioned gradual changing part 5” means that a portion between from the boundary between the non-recessed part 4 and the gradual changing part 5, to a position separated by a predetermined distance toward the bottom 3a of the recessed part 3 from the boundary between the non-recessed part 4 and the gradual changing part 5, is the wide angle face portion 6b.

Furthermore, the projected wide angle θb may be preferably more than 180 degrees and 190 degrees or less, more preferably more than 180 degrees and 185 degrees or less.

It also can be said that the projected wide angle θb is more than 180 degrees and 200 degrees or less means that, in other words, an angle between the wide angle face portion 6b and the horizontal direction is more than 0 degrees and 20 degrees or less, preferably more than 0 degrees be and 10 degrees or less, more preferably more than 0 degrees and 5 degrees or less.

Furthermore, the meaning of “the horizontal direction” in the angle between the wide angle face portion 6b and the horizontal direction is also same as the meaning of “the horizontal direction” in the gradual changing angle θ between the above-mentioned gradual changing part 5 and the horizontal direction, and/or the angle between the obtuse angle face portion 6a and the horizontal direction

And, the projected wide angle θb also may be less than the above-mentioned gradual changing angle θ, in this case, the projected wide angle θb is less than the above-mentioned gradual changing angle θ means that the angle against the horizontal direction becomes less as it approaches the non-recessed part 4 in the gradual changing part 5 (a slope becomes gentle).

The wide angle face portion 6b also may be a uniform approximately flat face (an approximately plane face), the wide angle face portion 6b may be a curved face (curve face), such as a face (a face to project upward) to swell upward (toward the non-recessed part 4 side), inversely, a face (a face to project downward) to swell downward (toward the recessed part 3 side) and so on.

Furthermore, in the case that the wide angle face portion 6b is the curve face to swell upward, it becomes difficult to rapidly change the height H (it becomes difficult to bend) at the boundary between the wide angle face portion 6b and the non-recessed part 4, it also can be said that it becomes difficult to visually recognize the boundary between the wide angle face portion 6b and the non-recessed part 4

And, it also can be said that it becomes difficult to visually recognize the boundary between the obtuse angle face portion 6a and the bottom 3a of the recessed part 3, as the above-mentioned projected wide angle θb gets closer to 180 degrees (the angle between the above-mentioned wide angle face portion 6b and the horizontal direction gets closer to 0 degrees, that is, as the wide angle face portion 6b inclines gentler across from the non-recessed part 4 to the gradual changing part 5).

### <The Skin Material 7>

As shown in FIGS. 1A to 7, the skin material 7 is a sheet-like object which is laminated on the surface 2a of the cushion base material 2.

If the skin material 7 is laminated on the surface 2a of the cushion base material 2, the raw material of the skin material 7 may be any raw material, for example, may be raw material of thermoplastic, such as a synthetic leather, a cloth such as a woven fabric, a knit fabric, a nonwoven fabric and so on, a film et cetera, besides, may be included a genuine leather (a natural leather) and so on.

Furthermore, at this point, a situation that “the skin material 7 is laminated on the surface 2a of the cushion base material 2” means that if the situation is a situation that the skin material 7 is stacked in a layer state on the surface 2a of the cushion base material 2, the situation is sufficient, it does not matter whether or not the skin material 7 and the cushion base material 2 mutually are fixed.

In the case that the skin material 7 is the synthetic leather, the synthetic leather may regard the cloth (fabric), such as the woven fabric (weaving fabric), the knit fabric (knitting fabric), the nonwoven fabric as a base material, may be what is coating, impregnating the base material with synthetic resin. Furthermore, in the synthetic leather, it also is said that what the base material is the nonwoven fabric and what is impregnated with synthetic resin is the artificial leather.

In the case that the skin material 7 is the woven fabric, the woven may include any woven structure, for example, the woven structure may be a plain weave, a twill weave, a satin weave, and/-or a multiple weave such as a double weave, a double weave or more and so on. Furthermore, some of the mentioned plain weave et cetera do not comprise a pile.

In the case that the skin material 7 is the woven fabric, the woven structure may be the above in addition to a pile woven fabric, such as a moquette weave, a wilton weave and so on.

In the case that the skin material 7 is the knit fabric, the knit fabric may be a warp knit such as a denbigh knit (tricot knit), a raschel knit, a double raschel knit, a vandyke knit (atlas knit), a cord knit and so on, a weft knit such as a plain knit (jersey knit), a ribbed knit (rib knit), a pearl knit and so on, may be any structure. Furthermore, some of the mentioned tricot knit et cetera usually do not comprise a pile.

In the case that the skin material 7 is the knit fabric, the knit fabric may be the above in addition to what is fluff-raised warp knitting fabric which is knitted by one reed or a plurality of reeds et cetera.

In the case that the skin material 7 is the nonwoven fabric, for example, the nonwoven fabric may be a needle-punching nonwoven fabric which fibers are mutually interlaced with hooking the fibers on a needle which goes and returns, besides, a thermal-bond nonwoven fabric which contains thermally fusible fibers and is shaped by heating, a chemical-bond nonwoven fabric which is shaped by sprayed working of emulsion resin such as acrylic resin, urethane resin et cetera, a spun-bond nonwoven fabric which combines long fibers (filaments) spun from nozzles by laminating on moving screen, what combines a stitch-bond nonwoven fabric et cetera by a needle-punching method and so on.

In the case that the skin material 7 is the cloth such as the woven fabric, the knit fabric, the nonwoven fabric and so on, the fibers which is included in the cloth may be a synthetic fibers which are raw material of thermoplastic, such as polyester fibers such as polyethylene terephthalate (PET), polytrimethylene terephthalate (PTT), polybutylene terephthalate (PBT) et cetera, nylon (polyamide) fibers, polyolefin-based fibers such as polyethylene (PE), polypropylene (PP) et cetera, rayon fibers, cupra fibers, acetate fibers, acrylic fibers whose main component is polyacrylonitrile (PAN), polyvinyl alcohol (PVA) fibers (vinylon fibers), polyurethane (PU) fibers and so on, besides, may be glass fibers, wool, silk and so on, these may be alone or in combination use.

Furthermore, in the case that the skin material 7 is the cloth such as the woven fabric, the knit fabric, the nonwoven fabric and so on, a fineness of the fibers which is included (knitted, woven) in the cloth also may be any value, for example, a total fineness of the fibers may be 20 dtex or more 3000 dtex or less.

If the skin material 7 is the sheet-like object such as the film and so on, the raw material which is included in the film may be synthetic resin, such as polyvinyl chloride (PVC) resin, polyester resin such as polyethylene terephthalate (PET), polytrimethylene terephthalate (PTT), polybutylene terephthalate (PBT) et cetera, polyamide (PA) resin, polyurethane (PU) resin and so on, these may be alone or in combination use. Furthermore, if the skin material 7 is the sheet-like object such as the film and so on, an external appearance of the sheet-like object (the surface 7a) may be genuine leather-like (genuine leathery, natural leathery).

In the case that the skin material 7 is formed by the above-mentioned raw material of thermoplastic, when the skin material 7 is heated et cetera by pressing of the embossing mold material 13, the portion to heat et cetera is degenerate (change in quality).

At this point, “degenerating of the skin material 7” in the present invention, as mentioned above, means that the surface property (gloss, ruggedness and so on), strength of the skin material 7 change according to melting, softening the skin material 7 by heat, chemicals et cetera. In particular, a portion, which is degenerated by pressing of the embossing mold material 13, of the skin material 7 becomes approximately flatter than other portion.

Inversely, though the skin material 7 is formed by the raw material of thermoplastic, if the non-recessed part 4 is not heated et cetera according to abutting (pressing) of the embossing mold material 13, the non-recessed part 4 becomes a portion (a non-degenerated portion) 7′ which the skin material 7 is not degenerate.

In the case that the recessed part 3 is formed according to the producing method described later of the sheet material (the embossing process E), the embossing mold material 13, it also can be said that the non-degenerated portion 7′, as mentioned above, a portion which the embossing mold material 13 described later does not abut (as it were, a non-embossing portion).

The above-mentioned skin material 7, as desired, may be added arbitrarily an extender pigment such as a titanium oxide, calcium carbonate et cetera, a filler (filling material), may be used raw material, which is added deodorizing agent, antibacterial agent, antifungal agent, fire proofing agent, water repellent agent, antifouling agent, coloring agent, aroma chemical, foaming agent et cetera, may be treated after be made as the skin material 7.

A pattern of the skin material 7 may be patternless, a design of plants such as flower, vegetation and so on, a design of animal, geometrical pattern, a pattern of surface ruggedness and so on, the pattern of the skin material 7 may be any pattern. a colour of the skin material 7 may be bluish colors, blackish colors, whitish colors, reddish colors, orangish colors, yellowish colors, greenish colors, purplish colors and so on, the colour of the skin material 7 may be any color tone, a value of chroma, brightness may be any value.

It also can be said that “the surface 7a” of the skin material 7 is a face of a side to expose, when using the sheet material 1 as the ornament (the door trim and so on), the arm rest, the instrument panel and so on in automobile et cetera.

Inversely, it also can be said that “a back face 1b” of the skin material 7 is a face of a side not to expose when using the sheet material 1 as the ornament, the arm rest, the instrument panel and so on.

A thickness 7w of the skin material 7 may be any value, for example, may be 0.1 mm or more and 3.0 mm or less, preferably 0.2 mm or more 2.0 mm or less, more preferably 0.3 mm or more 1.0 mm or less (0.5 mm and so on).

In the case that the skin material 7 is laminated on the surface 2a of the cushion base material 2, the recessed part 3 becomes to be formed according to recessing the skin material 7 and also the cushion base material 2.

And, the skin material 7 may be fixed to the surface 2a of the cushion base material 2 by bonding agent et cetera, besides, the skin material 7 and the cushion base material 2 each other may be heated welding, the skin material 7 and the cushion base material 2 may be fixed mutually, the skin material 7 may be fixed to the surface 2a of the cushion base material 2 by sewing.

### <The Main Gradual Changing Part 8>

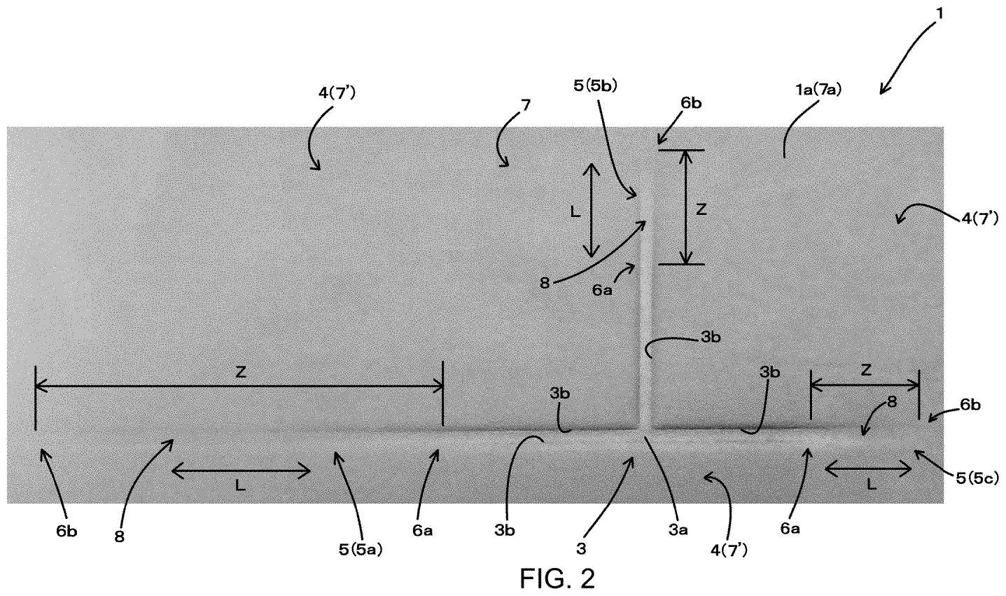

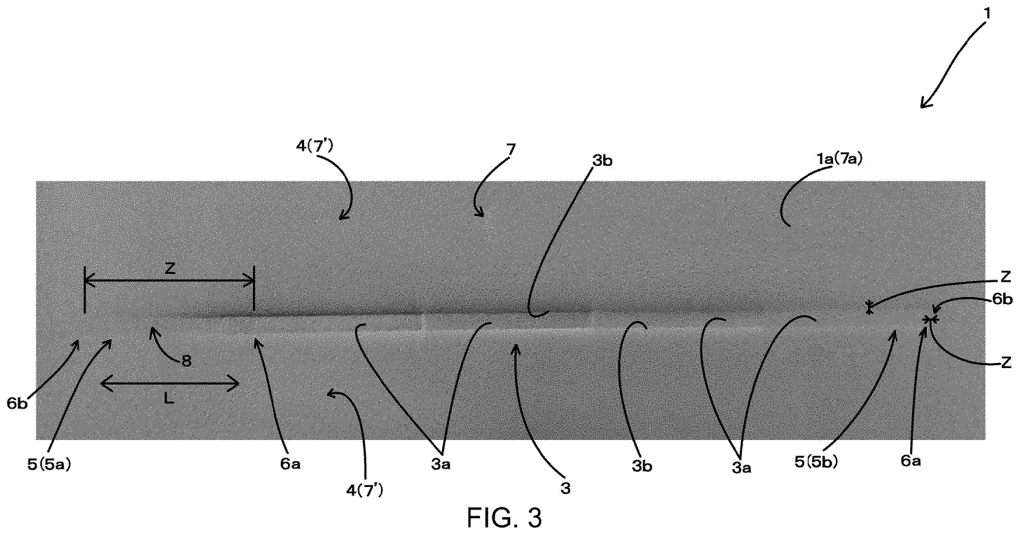

As shown in FIGS. 2 and 3, the main gradual changing part 8 is provided on at least one part of

the gradual changing part 5, the height H in the main gradual changing part 8 uniformly changes gradually across the recessed part 3 and the non-recessed part 4, and the main gradual changing part 8 comprises a gradual changing distance Z which is the longest distance from the bottom of the recessed part 3 to the non-recessed part 4 viewing in a plan-view, the main gradual changing part 8 comprises the main gradual changing direction L which is a direction of the gradual changing distance Z.

Furthermore, in the case that the gradual changing part 5 comprise the main gradual changing part 8 (the main gradual changing direction L), it can be said that each of the gradual changing parts 5 comprises one piece of the main gradual changing part 8. And, because there is the case that one piece of the recessed part 3 comprises the plurality pieces of the gradual changing parts 5, obviously, there is the case that one piece of the recessed part 3 comprises the plurality pieces of the main gradual changing parts 8.

The plurality pieces (for example, three pieces, seven pieces, twenty two pieces and so on) of the gradual changing parts 5, which the main gradual changing parts 8 are provided, may be provided in one sheet of the sheet material 1, one piece of the recessed part 3, the main gradual changing directions L, on the main gradual changing parts 8 of at least two pieces of the gradual changing parts 5, in the main gradual changing parts 8 of the plurality pieces of the gradual changing parts 5, may be in approximately parallel mutually.

At this point, the main gradual changing parts 8, which comprise the main gradual changing directions L being in approximately parallel mutually, may be provided in adjacent two pieces of the gradual changing parts 5, in the main gradual changing parts 8 of the plurality pieces of the gradual changing parts 5, the main gradual changing parts 8, which comprise the main gradual changing directions L being in approximately parallel mutually, may be provided in not adjacent two pieces of the gradual changing parts 5 (not adjacent two pieces of the gradual changing parts 5 means that, between the not adjacent two pieces of the gradual changing parts 5, one piece or more of the main gradual changing parts 8, which comprise the main gradual changing directions L being in approximately parallel mutually, may be provided).

And, the main gradual changing direction L on the main gradual changing part 8 may be curved, a curvature of the curved main gradual changing direction L may be constant, may change in the middle of the curved main gradual changing direction L. Furthermore, In the case that the main gradual changing direction L is curved, the gradual changing distance Z of the curved main gradual changing direction L becomes a distance along he curved main gradual changing direction L.

The height H in the side sectional-view of the main gradual changing part 8 (the sectional-view along a orthogonal direction to the main gradual changing direction L), as mentioned above, uniformly changes gradually across the recessed part 3 and the non-recessed part 4, the height H in the front sectional-view et cetera of the main gradual changing part 8 (the sectional-view along the main gradual changing direction L) are not particularly limited, for example, may be approximately U-shape, approximately V-shape, approximately rectangle (that is, the gradual changing angle θ is approximately 90 degrees) and so on.

And, if the main gradual changing parts 8 is provided in the adjacent gradual changing parts 5, for example, the recessed parts 3, which the front sectional-view et cetera of the recessed parts 3 is approximately U-shape and so on, are adjacent, the non-recessed part 4 becomes to exist between the recessed parts 3.

Some of the mentioned main gradual changing part 8 may join, branch, mutually intersect other main gradual changing part 8, the above-mentioned recessed part 3, the gradual changing part 5 in the middle (that is, the main gradual changing part 8 may comprise a joining portion, a branching portion, an intersecting portion). And, one piece of the main gradual changing part 8 may comprise a plurality pieces of the joining portion, the branching portion, the intersecting portion.

Below, we describe each of the examples of the sheet materials 1 in detail.

### The Example 1

As shown in FIG. 2, the example 1 of the sheet material 1 (the gradual changing part 5) comprises the plurality pieces (three pieces) of the gradual changing parts 5 against one piece of the recessed part 3, the three pieces of the gradual changing parts are 5a, 5b, 5c in FIG. 2.

And, the plan-view shape of the recessed part 3 in the example 1 combines two approximately belt-like shapes in inverted T-shape at a near part to right, the three pieces of the gradual changing parts 5a to 5c are formed on three pieces of the end parts in the approximately belt-like shapes in inverted T-shapes at a near part to right.

Each of the gradual changing parts 5a to 5c comprises both the obtuse angle face portion 6a and the wide angle face portion 6b. Furthermore, each of the gradual changing parts 5a to 5c comprises a spot which the recessed obtuse angle θa becomes 160 degrees or more and less than 180 degrees, it can be said that the spot is the obtuse angle face portion 6a, each of the gradual changing parts 5a to 5c comprises a spot which the projected wide angle θb becomes more than 180 degrees and 200 degrees or less, it can be said that the spot is the wide angle face portion 6b.

And, each of the gradual changing parts 5a to 5c comprises both the main gradual changing direction L and the secondary gradual changing direction.

Moreover, it can be said that any of the gradual changing parts 5a to 5c is the 4th embodiment not bending at both the boundary between the bottom 3a of the recessed part 3 and the gradual changing part 5, and the boundary between the non-recessed part 4 and the gradual changing part 5.

In gradual changing parts 5a to 5c of the example 1, the gradual changing distance Z along the main gradual changing direction L on the gradual changing part 5a is the longest (about 180 mm), the gradual changing angle θ along the main gradual changing direction L on the gradual changing part 5a is the least (about 0.3 degrees).

And, the gradual changing distance Z along the main gradual changing direction L on the gradual changing part 5b is the second longest next to the gradual changing part 5a (about 60 mm), the gradual changing angle θ along the main gradual changing direction L on the gradual changing part 5b is the second least next to the gradual changing part 5a (about 1.0 degrees), the gradual changing distance Z along the main gradual changing direction L on the gradual changing part 5c is the shortest (about 40 mm), the gradual changing angle θ along the main gradual changing direction L on the gradual changing part 5c is the most (about 1.4 degrees).

Furthermore, the cushion base material 2 in the example 1 is a double raschel knitting fabric, the skin material 7 is laminated on the surface side of the cushion base material 2, the skin material 7 is a film which the external appearance is genuine leather-like.

The thickness 1w of sheet material 1 in the example 1 is about 4.0 mm, thickness 2w of the cushion base material 2 is about 3.5 mm, the depth 3d of the recessed part 3 is about 1.0 mm, the thickness 7w of the skin material 7 is about 0.5 mm.

### The Example 2

As shown in FIG. 3, the example 2 of the sheet material 1 (the gradual changing part 5) comprises the plurality pieces (two pieces) of the gradual changing parts 5 against one piece of the recessed part 3, the two pieces of the gradual changing parts are 5a, 5b in FIG. 3.

And, the plan-view shape of the recessed part 3 in the example 2 becomes one approximately belt-like shape, the two pieces of the gradual changing parts 5a, 5b are formed on both ends in the approximately belt-like shape.

Each of the gradual changing parts 5a, 5b comprises both the obtuse angle face portion 6a and the wide angle face portion 6b. Furthermore, each of the gradual changing parts 5a, 5b comprises both the main gradual changing direction L and the secondary gradual changing direction, because the gradual changing distances Z of the gradual changing part 5b are uniform, it is not determined that any direction is the main gradual changing direction L and/or the secondary gradual changing direction.

And, it can be said that any of the gradual changing parts 5a, 5b is the 4th embodiment not bending at both the boundary between the bottom 3a of the recessed part 3 and the gradual changing part 5, and the boundary between the non-recessed part 4 and the gradual changing part 5.

Furthermore, the depth 3d of the recessed part 3 in the example 2 becomes shallow stepwisely (steps are formed) from the one to the other, each depth 3d of the steps, in order from the deeper part, are about 1.00 mm, about 0.75 mm, about 0.50 mm, about 0.25 mm.

In gradual changing parts 5a, 5b of the example 2, the gradual changing distance Z along the main gradual changing direction L on the gradual changing part 5a is longer (about 50 mm) than the gradual changing distance Z along the main gradual changing direction L on the gradual changing part 5b, the gradual changing angle θ along the main gradual changing direction L on the gradual changing part 5a is less (about 1.1 degrees) than the gradual changing angle θ along the main gradual changing direction L on the gradual changing part 5b.

And, the uniform gradual changing distance Z of the gradual changing part 5b is shorter (about 1.0 mm) than the uniform gradual changing distance Z of the gradual changing part 5a, the gradual changing angle θ of the gradual changing part 5b is larger (about 14.0 degrees) than the gradual changing angle θ of the gradual changing part 5a.

Other constitution, operation, effect and use mode of the sheet material 1 and the gradual changing part 5 of the example 2 are same as the example 1.

### The Example 3

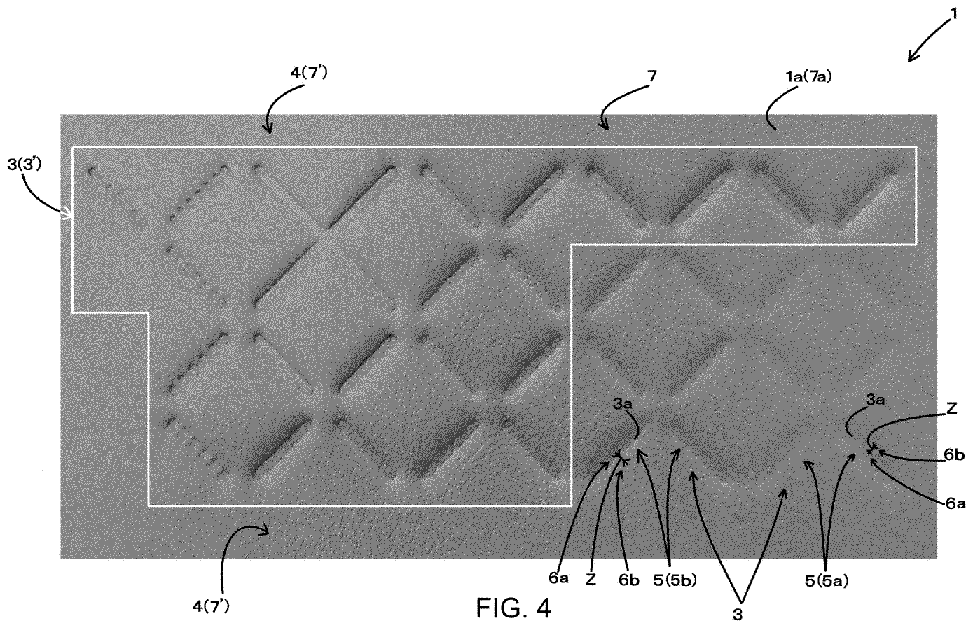

As shown in FIG. 4, the example 3 of the sheet material 1 (the gradual changing part 5) comprises the plurality pieces (twelve pieces) of the recessed parts 3, the example 3 comprises one piece of the gradual changing part 5 against each recessed part 3.

And, the plan-view shapes of the recessed parts 3 in the example 3 gathers four pieces of the recessed parts 3, the plan-view shapes are formed in approximately X-shape, or approximately square diamond-like shape.

Each of the gradual changing parts 5 comprises both the obtuse angle face portion 6a and the wide angle face portion 6b. Because the gradual changing distances Z of each of the gradual changing parts 5 are uniform, it is not determined that any direction is the main gradual changing direction L and/or the secondary gradual changing direction.

Furthermore, each depth 3d of the recessed parts 3 in the example 3 are different from every four pieces of the recessed parts 3 which is gathered in approximately X-shape, or approximately square diamond-like shape, each depth 3d of every six pieces of the steps, in order from the shallower part, are about 0.1 mm, about 0.2 mm.

In the example 3 (FIG. 4), the gradual changing parts, which is adjacent to the recessed parts 3 whose depth 3d are about 0.1 mm, are 5a, the gradual changing parts, which is adjacent to the recessed parts 3 whose depth 3d are about 0.2 mm, are 5b.

And, in the gradual changing parts 5a, 5b, the gradual changing parts 5a are the 4th embodiment not bending at both the boundary between the bottom 3a of the recessed part 3 and the gradual changing part 5, and the boundary between the non-recessed part 4 and the gradual changing part 5. It can be said that the gradual changing parts 5b are the 3rd embodiment bending at the boundary between the bottom 3a of the recessed part 3 and the gradual changing part 5, but not bending at the boundary between the non-recessed part 4 and the gradual changing part 5.

In the gradual changing parts 5a, 5b of the example 3, the uniform gradual changing distances Z of the gradual changing parts 5a are about 1.0 mm, the gradual changing angles θ of the gradual changing parts 5a are less (about 5.7 degrees) than the gradual changing angle θ of the gradual changing part 5b.

And, the uniform gradual changing distances Z of the gradual changing parts 5b also are about 1.0 mm, the gradual changing angles θ of the gradual changing parts 5b are more (about 11.3 degrees) than the gradual changing angle θ of the gradual changing part 5a.

At this point, the recessed parts shown by symbol 3′ in FIG. 4 comprise portions which stand from the bottoms 3a of the recessed parts 3′, and do not comprise the gradual changing part 5 in the present invention.

And, if only at least one recessed part 3, which comprises the gradual changing part 5 in the present invention, is formed in any portion of a sheet material, it can be said that the sheet material is the sheet material 1 of the present invention.

Other constitution, operation, effect and use mode of the sheet material 1 and the gradual changing part 5 of the example 3 are same as the examples 1, 2.

### The Example 4

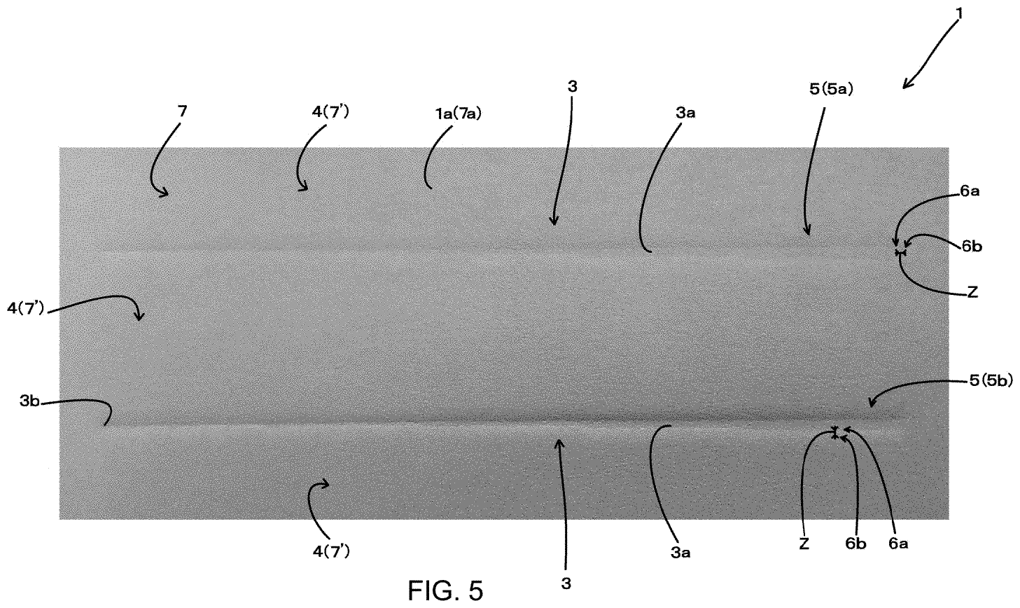

As shown in FIG. 5, the example 4 of the sheet material 1 (the gradual changing part 5) comprises the plurality pieces (two pieces) of the recessed parts 3, the example 4 comprises one piece of the gradual changing part 5 against each recessed part 3.

And, the plan-view shapes of the recessed parts 3 in the example 4 are approximately belt-like, widths of the recessed parts 3 in the example 4 become wide stepwisely from the one to the other.

Each of the gradual changing parts 5 comprises both the obtuse angle face portion 6a and the wide angle face portion 6b. Because the gradual changing distances Z of each of the gradual changing parts 5 are uniform, it is not determined that any direction is the main gradual changing direction L and/or the secondary gradual changing direction.

Furthermore, each depth 3d of the recessed parts 3 in the example 4 are different mutually, each depth 3d of the steps, in order from the shallower part, are about 0.25 mm, about 0.50 mm.

In the example 4 (FIG. 5), the gradual changing parts, which is adjacent to the recessed parts 3 whose depth 3d are about 0.25 mm, are 5a, the gradual changing parts, which is adjacent to the recessed parts 3 whose depth 3d are about 0.50 mm, are 5b.

And, any of gradual changing parts 5a, 5b also are the 4th embodiment not bending at both the boundary between the bottom 3a of the recessed part 3 and the gradual changing part 5, and the boundary between the non-recessed part 4 and the gradual changing part 5. Furthermore, portions (the recessed inner peripheries 3b), which stand from the bottoms 3a, are formed on the narrowest one end in the gradual changing part 5b.

In the gradual changing parts 5a, 5b of the example 4, the uniform gradual changing distances Z of the gradual changing parts 5a are about 1.0 mm, the gradual changing angles θ of the gradual changing parts 5a are less (about 14.0 degrees) than the gradual changing angle θ of the gradual changing part 5b.

And, the uniform gradual changing distances Z of the gradual changing parts 5b also are about 1.0 mm, the gradual changing angles θ of the gradual changing parts 5b are more (about 26.6 degrees) than the gradual changing angle θ of the gradual changing part 5a.

Other constitution, operation, effect and use mode of the sheet material 1 and the gradual changing part 5 of the example 4 are same as the examples 1 to 3.

### The Example 5

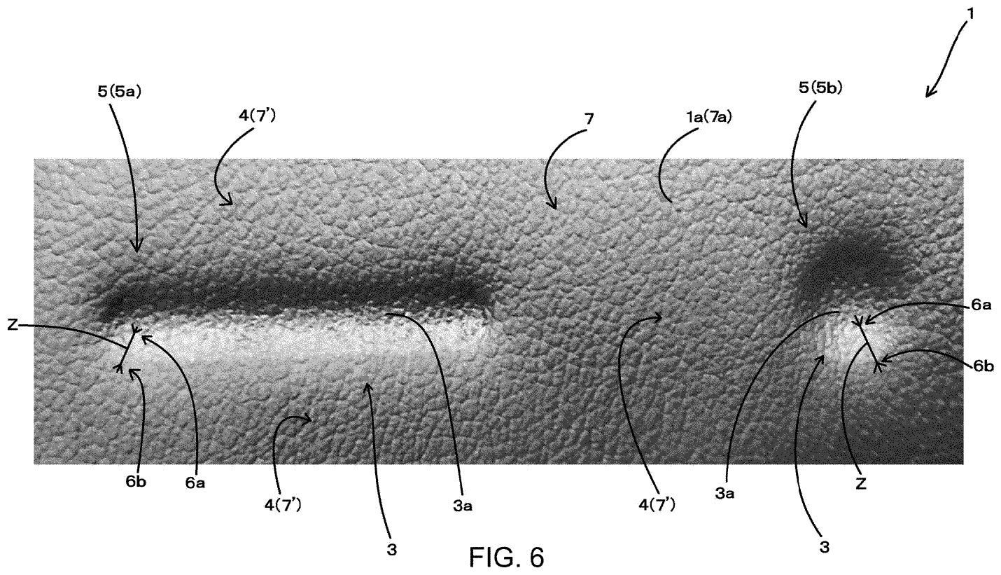

As shown in FIG. 6, the example 5 of the sheet material 1 (the gradual changing part 5) comprises the plurality pieces (two pieces) of the recessed parts 3, the example 5 comprises one piece of the gradual changing part 5 against each recessed part 3.

And, the one of the plan-view shapes of the recessed parts 3 in the example 5 is approximately circular, the other of the plan-view shapes of the recessed parts 3 in the example 5 is approximately rod-like which both end part of the recessed part 3 are round.

Each of the gradual changing parts 5 comprises both the obtuse angle face portion 6a and the wide angle face portion 6b. Because the gradual changing distances Z of each of the gradual changing parts 5 are uniform, it is not determined that any direction is the main gradual changing direction L and/or the secondary gradual changing direction.

Furthermore, it also can be said that each of the bottoms 3a of the recessed parts 3 in the example 5 becomes a curve face (or, it difficult to visually recognize the bottoms 3a clearly), the depth 3d of the deepest spot in each of the recessed part 3 is about 1.0 mm.

In the example 5 (FIG. 6), the gradual changing parts, which is adjacent to approximately rod-like recessed parts, are 5a, the gradual changing parts, which is adjacent to approximately circular shape recessed parts 3, are 5b.

And, any of gradual changing parts 5a, 5b also are the 4th embodiment not bending at both the boundary between the bottom 3a of the recessed part 3 and the gradual changing part 5, and the boundary between the non-recessed part 4 and the gradual changing part 5.

In the gradual changing parts 5a, 5b of the example 5, the uniform gradual changing distances Z of the gradual changing parts 5a are about 3.0 mm, the gradual changing angles θ of the gradual changing parts 5a are almost the same (about 18.4 degrees) than the gradual changing angle θ of the gradual changing part 5b.

And, the uniform gradual changing distances Z of the gradual changing parts 5b also are about 3.0 mm, the gradual changing angles θ of the gradual changing parts 5b are almost the same (about 18.4 degrees) than the gradual changing angle θ of the gradual changing part 5a.

Other constitution, operation, effect and use mode of the sheet material 1 and the gradual changing part 5 of the example 5 are same as the examples 1 to 4.

### The Example 6

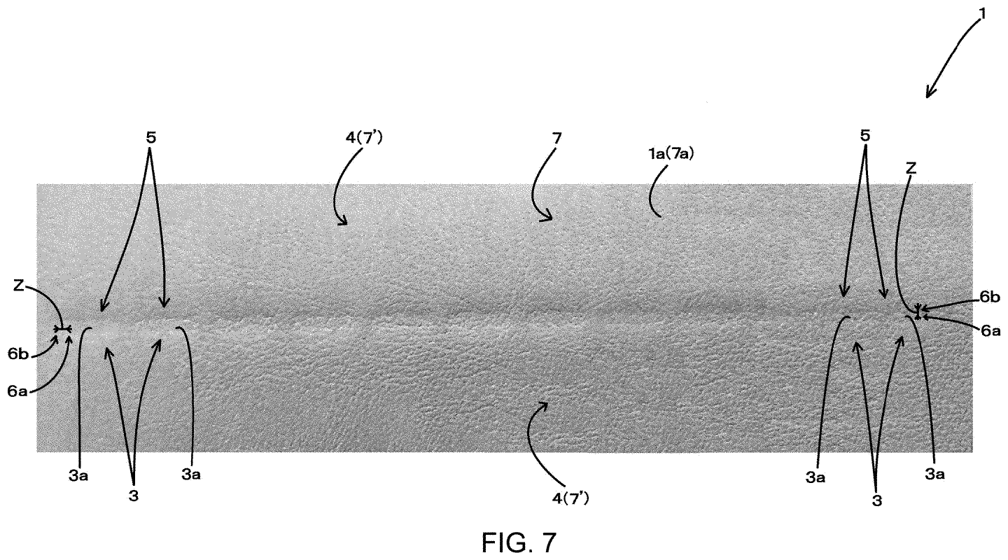

As shown in FIG. 7, the example 6 of the sheet material 1 (the gradual changing part 5) comprises the plurality pieces (twelve pieces) of the recessed parts 3, the example 6 comprises one piece of the gradual changing part 5 against each recessed part 3.

And, all plan-view shapes of the recessed parts 3 in the example 6 are approximately rod-like which both end part of the recessed part 3 are round.

Each of the gradual changing parts 5 comprises both the obtuse angle face portion 6a and the wide angle face portion 6b. Because the gradual changing distances Z of each of the gradual changing parts 5 are uniform, it is not determined that any direction is the main gradual changing direction L and/or the secondary gradual changing direction.

Furthermore, each depth 3d of the recessed parts 3 in the example 6 are different mutually, each depth 3d of the steps become deep by gradation at the interval of about 0.028 mm from about 0.028 mm to about 0.336 mm (in other words, each depth 3d of the steps, in order from the shallower part, are about 0.028 mm, about 0.056 mm, about 0.084 mm, about 0.112 mm, about 0.140 mm, about 0.168 mm, about 0.196 mm, about 0.224 mm, about 0.252 mm, about 0.280 mm, about 0.308 mm, about 0.336 mm).

And, in the twelve pieces of the gradual changing part 5, it can be said that the recessed part 3, whose depth 3d is the deepest about 0.336 mm, and the recessed part 3, whose depth 3d is the second deepest about 0.308 mm, are the 3rd embodiment bending at the boundary between the bottom 3a of the recessed part 3 and the gradual changing part 5, but not bending at the boundary between the non-recessed part 4 and the gradual changing part 5, it can be said that other remaining ten pieces of the recessed part 3 are the 4th embodiment not bending at both the boundary between the bottom 3a of the recessed part 3 and the gradual changing part 5, and the boundary between the non-recessed part 4 and the gradual changing part 5.

The uniform gradual changing distances Z of each of the gradual changing parts 5 in the example 6 are about 1.0 mm, the gradual changing angles θ of each of the gradual changing parts 5 in the example 6 become more by gradation from the gradual changing part 5, which is adjacent to the recessed parts 3 whose depth 3d is the shallowest, to the gradual changing part 5, which is adjacent to the recessed parts 3 whose depth 3d is the deepest (about 1.6 degrees, about 3.2 degrees, about 4.8 degrees, about 6.3 degrees, about 7.9 degrees, about 9.5 degrees, about 11.0 degrees, about 12.5 degrees, about 14.0 degrees, about 15.5 degrees, about 17.0 degrees, about 18.4 degrees).

Other constitution, operation, effect and use mode of the sheet material 1 and the gradual changing part 5 of the example 6 are same as the examples 1 to 5.

### The Example 7

The example 7 of the sheet material 1 (the gradual changing part 5) comprises the plurality pieces of the recessed parts 3, the example 7 comprises the plurality pieces of the gradual changing parts 5 against each recessed part 3, the main gradual changing part 8 is provided on each of the gradual changing parts 5, each of the main gradual changing directions L of the main gradual changing parts 8 become in approximately parallel become mutually, the number of the main gradual changing parts 8 is twenty two pieces.

Accordingly, each of the main gradual changing directions L of the main gradual changing parts 8 in the example 7 is along a predetermined direction, the example 7 can realize “the gradation along a predetermined direction across the recessed part 3 and the non-recessed part 4”.

Each of the gradual changing parts 5, which the main gradual changing parts 8 are provided, comprises both the obtuse angle face portion 6a and the wide angle face portion 6b. Furthermore, each of the gradual changing parts 5 comprises a spot which the recessed obtuse angle θa becomes 160 degrees or more and less than 180 degrees, it can be said that the spot is the obtuse angle face portion 6a, each of the gradual changing parts 5 comprises a spot which the projected wide angle θb becomes more than 180 degrees and 200 degrees or less, it can be said that the spot is the wide angle face portion 6b.

And, each of the gradual changing parts 5 comprises both the main gradual changing direction L and the secondary gradual changing direction.

Moreover, it can be said that any of the gradual changing parts 5 is the 4th embodiment not bending at both the boundary between the bottom 3a of the recessed part 3 and the gradual changing part 5, and the boundary between the non-recessed part 4 and the gradual changing part 5.

In the gradual changing parts 5 of the example 7, the longest gradual changing distance Z along the main gradual changing directions L on the gradual changing parts 5 is about 220 mm, the gradual changing angle θ along the main gradual changing direction L on the gradual changing part 5 is the least (about 0.3 degrees).

And, in the gradual changing parts 5 of the example 7, the shortest gradual changing distance Z along the main gradual changing directions L on the gradual changing parts 5 is about 90 mm, the gradual changing angle θ along the main gradual changing directions L on the gradual changing parts 5 is about 0.6 degrees.

Furthermore, each of the recessed parts 3, the main gradual changing parts 8 is provided on only each of one end sides of the main gradual changing directions L, the gradual changing part 5, which the gradual changing distances Z is about 4.0 mm, and the gradual changing angles θ is about 14.0 degrees, is provided on each of other end sides of the main gradual changing directions L.

Each of the gradual changing parts 5 on the other end sides of the main gradual changing directions L are provided along one curve line by connecting the plan-view shapes of the adjacent gradual changing parts 5 on the other end sides of the main gradual changing directions L, it also can be said that the example 7 comprises the plurality pieces of the recessed parts 3 which look a shell-like shape (a bird wings-like shape) as the whole example 7 by combining the one curve line and each of the plan-view shapes of the main gradual changing parts 8 on the one end sides of the main gradual changing directions L.

And, one main gradual changing part 8 in the example 7 comprises a joining portion to adjacent other main gradual changing part 8, a branching portion to the other main gradual changing part 8.

Furthermore, the cushion base material 2 in the example 7 also is a double raschel knitting fabric, the skin material 7 is laminated on the surface side of the cushion base material 2, the skin material 7 is a film which the external appearance is genuine leather-like.

The thickness 1w of sheet material 1 in the example 7 is about 4.0 mm, thickness 2w of the cushion base material 2 is about 3.5 mm, the depth 3d of the recessed part 3 is about 1.0 mm, the thickness 7w of the skin material 7 is about 0.5 mm.

Other constitution, operation, effect and use mode of the sheet material 1 and the gradual changing part 5 of the example 7 are same as the examples 1 to 6.

### The Example 8

The example 8 of the sheet material 1 (the gradual changing part 5) comprises the plurality pieces of the recessed parts 3, the example 8 comprises the plurality pieces of the gradual changing parts 5 against each recessed part 3, the main gradual changing parts 8 are provided on only a part of the plurality pieces of the gradual changing parts 5. The number of the main gradual changing part 8 is seven pieces, each of the main gradual changing directions L of the main gradual changing parts 8 are curved (each curvature of the main gradual changing directions L are different mutually, each of the curving direction are curved identically), moreover, a part of the main gradual changing directions L are in approximately parallel mutually, other portion of the main gradual changing directions L are not in approximately parallel mutually.

Accordingly, each of the main gradual changing directions L of the main gradual changing parts 8 in the example 8 are along the plurality pieces of predetermined directions, the example 8 can realize the gradation et cetera along the plurality pieces of predetermined directions while having a spread.

Each of the gradual changing parts 5, which the main gradual changing parts 8 are provided, comprises both the obtuse angle face portion 6a and the wide angle face portion 6b. Furthermore, each of the gradual changing parts 5 comprises a spot which the recessed obtuse angle θa becomes 160 degrees or more and less than 180 degrees, it can be said that the spot is the obtuse angle face portion 6a, each of the gradual changing parts 5 comprises a spot which the projected wide angle θb becomes more than 180 degrees and 200 degrees or less, it can be said that the spot is the wide angle face portion 6b.

And, each of the gradual changing parts 5 comprises both the main gradual changing direction L and the secondary gradual changing direction.

Moreover, it can be said that any of the gradual changing parts 5 is the 4th embodiment not bending at both the boundary between the bottom 3a of the recessed part 3 and the gradual changing part 5, and the boundary between the non-recessed part 4 and the gradual changing part 5.

In the gradual changing parts 5 of the example 8, the longest gradual changing distance Z along the main gradual changing directions L on the gradual changing parts 5 is about 100 mm, the gradual changing angle θ along the main gradual changing direction L on the gradual changing part 5 is the least (about 0.3 degrees).

And, in the gradual changing parts 5 of the example 8, the shortest gradual changing distance Z along the main gradual changing directions L on the gradual changing parts 5 is about 30 mm, the gradual changing angle θ along the main gradual changing directions L on the gradual changing parts 5 is about 0.6 degrees.

Furthermore, in each recessed part 3, the plan-view shapes of the recessed parts 3 not comprising the gradual changing part 5, which the main gradual changing part 8 is provided, are curved, each curvature of the plan-view shapes are different, each of the curving direction are curved identically.

And, majority of the recessed parts 3, the gradual changing parts 5 in the example 8 comprise intersecting portions of other recessed parts 3, other gradual changing parts 5, moreover as for, the majority of the recessed parts 3, the gradual changing parts 5 comprise the plurality of the intersecting portion (the majority of the recessed parts 3, the gradual changing parts 5 intersect the other recessed parts 3, the other gradual changing parts 5 multiple times), it also can be said that the example 8 comprises the plurality pieces of the recessed parts 3 which look a curved lattice-like shape as the whole example 8.

Furthermore, the cushion base material 2 in the example 8 also is a double raschel knitting fabric, the skin material 7 is laminated on the surface side of the cushion base material 2, the skin material 7 is a film which the external appearance is genuine leather-like.

The thickness 1w of sheet material 1 in the example 8 is about 2.0 mm, thickness 2w of the cushion base material 2 is about 1.5 mm, the depth 3d of the recessed part 3 is about 0.5 mm, about 0.3 mm, the thickness 7w of the skin material 7 is about 0.5 mm.

Other constitution, operation, effect and use mode of the sheet material 1 and the gradual changing part 5 of the example 8 are same as the examples 1 to 6.

### <The Producing Method of the Sheet Material, the Embossing Process E, the Embossing Mold Material 13>

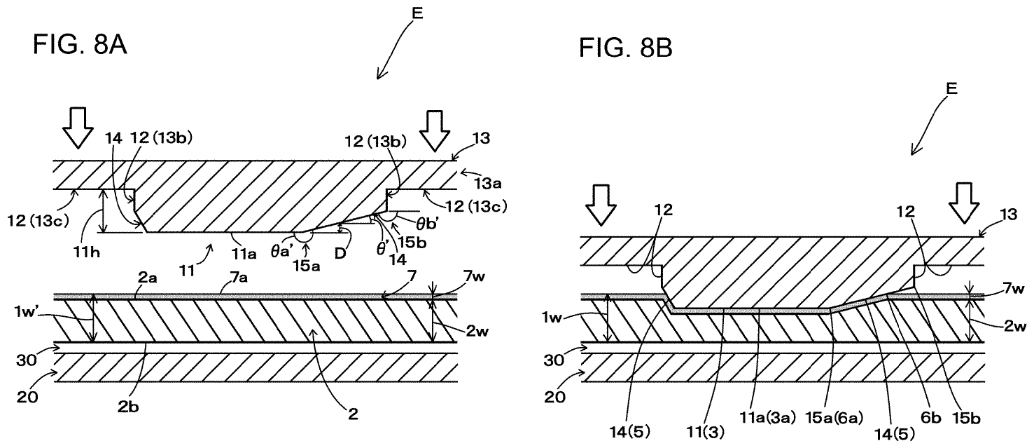

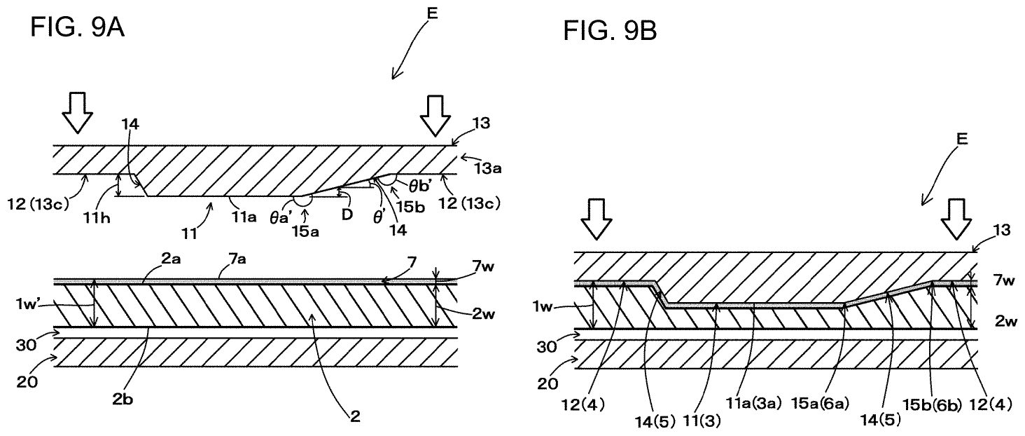

As shown in FIGS. 8A, 8B, 9A and 9B, the producing method of the sheet material comprises the embossing process E pressing the embossing mold material 13 on the surface (the surface 2a, the surface 7a of the skin material 7) side of the cushion base material 2, the producing method is a method producing the sheet material which the recessed part 3 and the non-recessed part 4 are formed on the surface 2a side of the cushion base material 2.

In the embossing process E, the above-mentioned recessed part 3, the gradual changing part 5 et cetera are provided according to pressing the embossing mold material 13 in the situation that the embossing projected part 11 and the embossing gradual changing part 14 are abutting to the surface 2a side of the cushion base material 2, the surface 7a side of the skin material 7.

We describe the embossing process E in detail. In the embossing process E, the recessed part 3 et cetera is formed, according to holding the cushion base material 2, the skin material 7 before forming the recessed part 3 between the embossing mold material 13, which comprises the embossing projected part 11 and the embossing non-projected part 12, and an embossing receiving mold 20, which receives the embossing mold material 13, according to pressing the embossing mold material 13 (that is, the embossing projected part 11 et cetera) from the surface 2a side of the cushion base material 2 to the embossing receiving mold 20 direction under a predetermined condition.

The above condition in the embossing process E, if the recessed part 3 et cetera is formed, is not particularly limited, the condition may be a predetermined value depending on raw material of the cushion base material 2, the skin material 7, which are object to press (to emboss), for example, in a temperature (an embossing temperature) of the embossing mold material 13, the embossing receiving mold 20, the temperature of the embossing mold material 13 may be 140° C., the temperature of the embossing receiving mold 20 may be 180° C. and so on, a pressing time may be 30 seconds and so on.

Furthermore, regarding the condition of the embossing process E (the embossing temperature, the pressing time and so on), it also can be said that the case that the cushion base material 2 is the double raschel knitting fabric becomes possible to do reduction of the embossing temperature, shortening of the pressing time and so on as compared with the case that the cushion base material 2 is the urethane foam et cetera.

And, in the case that the cushion base material 2 is the double raschel knitting fabric, as mentioned above, it can attain further improvement of cushioning property as the sheet material 1, reduction of the bottom reach-feeling, improvement of durability.

The constitution of the embossing mold material 13, the embossing receiving mold 20, if the recessed part 3, the gradual changing part 5 et cetera are formed, is not particularly limited, for example, the embossing mold material 13 and the embossing receiving mold 20 may be flat-like shape, may be roll-like shape.

For example, in the case that the embossing mold material 13, the embossing receiving mold 20 is the roll-like shape, a longer direction of the embossing projected part 11, an embossing main gradual changing direction of the embossing gradual changing part 14 described later may be approximately along a roll circumferential direction, a roll axial direction.

Besides, in the case that the embossing mold material 13 and the embossing receiving mold 20 is the roll-like shape, it becomes easy to form the recessed part 3 et cetera on the cushion base material 2 et cetera with keeping it approximately constant that an interstice between the roll of the embossing mold material 13 side and the embossing receiving mold 20 side, pressing force, according to making it almost the same that a height of a roll end part of the embossing mold material 13 side (at least one of or both the roll end parts) and a height of the embossing projected part 11, and according to using the cushion base material 2, the skin material 7, which comprise a width not abutting against the roll end part whose height is almost the same, according to the roll end part mainly abutting against the roll of the embossing receiving mold 20 side.

And, in the embossing process E, the embossing projected part 11 may be pressed in the situation that a sheet-like object (a underlay sheet) 30, which is elastomer raw material and comprises heat resistant such as silicone resin et cetera, is laid under the cushion base material 2 (back face 2b side of the cushion base material 2).

### <The Embossing Projected Part 11, the Embossing Non-Projected Part 12, the Embossing Mold Material 13>

As shown in FIGS. 8A, 8B, 9A and 9B the embossing projected part 11 is a projected portion (a mountain portion), which is provided as standing from a base part 13a of the embossing mold material 13 (in standing state), it also can be said that the embossing projected part 11 in the embossing mold material 13 is equivalent to the recessed part 3 in the sheet material 1.

Furthermore, there are the case (refer to FIGS. 8A and 8B) that the embossing projected part 11 is standing through a step 13b, which stands at about 90 degrees from the base part 13a of the embossing mold material 13, and the case (refer to FIGS. 9A and 9B) that the embossing projected part 11 is directly standing from the base part 13a of the embossing mold material 13.

The embossing projected part 11 comprises the embossing gradual changing part 14 described later, the embossing gradual changing part 14 may comprise an embossing wide angle portion 15a described later, an embossing obtuse angle face portion 15b.

Besides, regarding the embossing projected part 11, the embossing non-projected part 12, the embossing mold material 13 et cetera, it also can be said that the recessed part 3 in the above-mentioned sheet material 1 is equivalent to the embossing projected part 11.

Hereinafter similarly, regarding the embossing projected part 11, the embossing non-projected part 12 and the embossing mold material 13 et cetera, it also can be said that the bottom 3a of the recessed part 3 in the sheet material 1 is equivalent to a top 11a of the embossing projected part 11, the recessed inner periphery 3b of the recessed part 3 is equivalent to a projected outer periphery of the embossing projected part 11, the depth 3d of the recessed part 3 is equivalent to a height 11H of the embossing projected part 11, the non-recessed part 4 is equivalent to the embossing non-projected part 12, the gradual changing part 5 is equivalent to the embossing gradual changing part 14, the height H (the height H from the bottom 3a of the recessed part 3) is equivalent to the depth D (the depth D of the top 11a of the embossing projected part 11), the obtuse angle face portion 6a, which the angle (the recessed obtuse angle) θa between the obtuse angle face portion 6a and the bottom 3a surface of the recessed part 3 is 160 degrees or more and less than 180 degrees, is equivalent to the embossing wide angle portion 15a, which an angle (a projected wide angle) θa′ between the embossing wide angle portion 15a and the top 11a surface of the embossing projected part 11 is more than 180 degrees and 200 degrees or less, the wide angle face portion 6b, which the angle (the projected wide angle) θb between the wide angle face portion 6b and the surface of the non-recessed part 4 is more than 180 degrees and 200 degrees or less, is equivalent to the embossing obtuse angle face portion 15b, an angle (a recessed obtuse angle) θb′ between the embossing obtuse angle face portion 15b and the surface of the embossing non-projected part 12 is 160 degrees or more and less than 180 degrees.

<The Embossing Non-Projected Part 12 and so on>

As shown in FIGS. 8A, 8B, 9A and 9B the embossing non-projected part 12 is other portion than the above-mentioned embossing projected part 11 in the embossing mold material 13.

Therefore, in the case (refer to FIGS. 8A and 8B) that the embossing projected part 11 is standing through a step 13b, which stands at about 90 degrees from the base part 13a of the embossing mold material 13, the embossing non-projected part 12 includes not only a surface 13c of the base part 13a of the embossing mold material 13 but also step 13b, in the case (refer to FIGS. 9A and 9B) that the embossing projected part 11 is directly standing from the base part 13a of the embossing mold material 13, the embossing non-projected part 12 points to only a surface 13c of the base part 13a of the embossing mold material 13.

It also can be said that the embossing non-projected part 12 is a portion surrounding a periphery of the embossing projected part 11 viewing in a plan-view, in the case that the plurality pieces of the embossing projected part 11 are formed, it also can be said that the embossing non-projected part 12 is a clearance between the adjacent two pieces of the recessed parts 3, it also can be said that the embossing non-projected part 12 is a portion except the embossing projected part 11 from an embossing face (the embossing face is a face abutting the cushion base material 2, the skin material 7, the embossing face is a face of a portion, which joins the embossing projected part 11, the embossing gradual changing part 14, the surface 13c of the base part 13a of the embossing mold material 13 and so on) of the embossing mold material 13.

The plan-view shape of the embossing non-projected part 12 becomes a shape except one piece or plurality pieces of the embossing projected parts 11 from the embossing face of the embossing mold material 13.

And, it also can be said that the embossing non-projected part 12 is equivalent to the non-recessed part 4 of the sheet material 1, there is the case (refer to FIGS. 8A and 8B) that the embossing non-projected part 12 is non-contacting (non-abutting, non-pressing) against the cushion base material 2, the skin material 7, in the case, a portion, which the embossing mold material 13 described later does not be pressed (as it were, a non-embossing portion), occurs in the cushion base material 2, the skin material 7.

At this point, as shown in FIGS. 8A and 8B, the case, that the embossing non-projected part 12 is non-contacting (does not contact) the cushion base material 2, the skin material 7 in the embossing process E, is “the 1st embodiment” of the producing method of the sheet material, if a distance between the above-mentioned embossing mold material 13 and the embossing receiving mold 20 is more than a thickness (a thickness before embossing, that is, only the thickness 2w of the cushion base material 2 sole, a thickness which adds the thickness 2w to the thickness 7w of the skin material 7) 1w′ of the sheet material 1 before the embossing process E.

Furthermore, though FIGS. 8A and 8B show that the embossing mold material 13 comprises the step 13b, the embossing mold material 13, which does not comprise the step 13b, and which the embossing projected part 11 directly stands from the base part 13a the embossing mold material 13, may be used in the 1st embodiment of the producing method of the sheet material.

On the other hand, as shown in FIGS. 9A and 9B, the case, that the embossing non-projected part 12 contacts the cushion base material 2, the skin material 7 in the embossing process E, is “the 2nd embodiment” of the producing method of the sheet material, if a distance between the above-mentioned embossing mold material 13 and the embossing receiving mold 20 is the thickness 1w′ before embossing or less. Furthermore, it also can be said that the embossing mold material 13, which comprises the step 13b, can not be used in the 2nd embodiment (because a portion, which the height H between the recessed part 3 and the non-recessed part 4 in the sheet material produced by the 2nd embodiment of the producing method of the sheet, is formed, if the step 13b exists between the base part 13a of the embossing mold material 13 and the embossing projected part 11).

### <The Embossing Gradual Changing Part 14, the Embossing Wide Angle Portion 15a, the Embossing Obtuse Angle Face Portion 15b and so On>

As shown in FIGS. 8A, 8B, 9A and 9B the embossing gradual changing part 14 is a portion which the depth D from the top 11a of the embossing projected part 11 changes gradually like the gradual changing part 5 of the above-mentioned sheet material 1, it also can be said that the embossing gradual changing part 14 is a inclined face (a gradual changing face) provided across the embossing projected part 11 to the embossing non-projected part 12.

At this point, “the depth D from the top 11a of the embossing projected part 11 changes gradually” means that the depth D becomes deep er by gradation as it approaches from the top 11a of the embossing projected part 11 to the embossing non-projected part 12, and means that after the depth D becoming deep er by gradation, the depth D becoming shallow er by gradation, and the depth D again becoming deep er by gradation while it reached the top 11a of the embossing projected part 11 to the embossing non-projected part 12 and so on, it does not include a portion (a bending portion) in which the depth D changes rapidly (in other words, a side sectional-view shape of the embossing gradual changing part 14 does not comprise a bending point (a point which a tangential line is not determined uniquely), and, the embossing gradual changing part 14 does not include a portion which intersects at approximately 90 degrees against the top 11a of the embossing projected part 11.

And, “across from the embossing projected part 11 to the embossing non-projected part 12” means that, in the case that the above-mentioned embossing non-projected part 12 includes the surface 13c and the step 13b in the base part 13a of the embossing mold material 13, across from the embossing projected part 11 to the step 13b of the embossing mold material 13, in the case that the embossing non-projected part 12 points to only the surface 13c in the base part 13a of the embossing mold material 13, across from the embossing projected part 11 to the surface 13c of the base part 13a of the embossing mold material 13.

Moreover, the embossing gradual changing part 14 may comprise the embossing wide angle portion 15a which is provided on a near part to the top 11a of the embossing projected part 11, may comprise the embossing obtuse angle face portion 15b which is provided on a near part of the embossing non-projected part 12, may comprise both the embossing wide angle portion 15a and the embossing obtuse angle face portion 15b, may comprise only either one of the embossing wide angle portion 15a and the embossing obtuse angle face portion 15b, don't have to comprise both the embossing wide angle portion 15a and the embossing obtuse angle face portion 15b.

Besides, regarding the embossing gradual changing part 14, the embossing wide angle portion 15a, the embossing obtuse angle face portion 15b et cetera, it also can be said that the recessed part 3 in the above-mentioned sheet material 1 is equivalent to the embossing projected part 11.

Hereinafter similarly, regarding the embossing gradual changing part 14, the embossing wide angle portion 15a, the embossing obtuse angle face portion 15b et cetera, it also can be said that the bottom 3a of the recessed part 3 in the sheet material 1 is equivalent to the top 11a of the embossing projected part 11, the recessed inner periphery 3b of the recessed part 3 is equivalent to a projected outer periphery of the embossing projected part 11, the non-recessed part 4 is equivalent to the embossing non-projected part 12, the gradual changing part 5 is equivalent to the embossing gradual changing part 14, the height H (the height H from the bottom 3a of the recessed part 3) is equivalent to the depth D (the depth D from the top 11a of the embossing projected part 11), the main gradual changing direction L is equivalent to an embossing main gradual changing direction, the secondary gradual changing direction is equivalent to an embossing secondary gradual changing direction, the gradual changing distance Z is equivalent to an embossing gradual changing distance, the gradual changing angle θ is equivalent to an embossing gradual changing angle θ′, the obtuse angle face portion 6a, which the angle (the recessed obtuse angle) θa between the obtuse angle face portion 6a and the bottom 3a surface of the recessed part 3 is 160 degrees or more and less than 180 degrees, is equivalent to the embossing wide angle portion 15a, which an angle (a projected wide angle) θa′ between the embossing wide angle portion 15a and the top 11a surface of the embossing projected part 11 is more than 180 degrees and 200 degrees or less, the angle (the recessed obtuse angle) θa between the obtuse angle face portion 6a and the bottom 3a surface of the recessed part 3 is equivalent to an angle (a projected wide angle) θa′ between the embossing wide angle portion 15a and the top 11a surface of the embossing projected part 11, the angle (the projected wide angle) θb between the wide angle face portion 6b and the surface of the non-recessed part 4 is equivalent to an angle (a recessed obtuse angle) θb′ between the embossing obtuse angle face portion 15b and the surface of the embossing non-projected part 12.

That is, it can be said that the embossing mold material 13 comprises at least one embossing wide angle portion 15a which is formed on at least a part of a near part to a top surface of the embossing projected part 11 in the embossing gradual changing part 14, an angle θa′, between the embossing wide angle portion 15a and a top surface of the embossing projected part 11, is more than 180 degrees and 200 degrees or less, and/or, the embossing mold material 13 comprises at least one embossing obtuse angle face portion 15b which is formed on at least a part of a near part to the surface of the embossing non-projected part 12 in the embossing gradual changing part 14, an angle θb, between the embossing obtuse angle face portion 15b and the surface of the embossing non-projected part 12, is 160 degrees or more and less than 180 degrees.

And, the embossing mold material 13 may comprise at least one embossing main gradual changing part which is provided in at least one part of the embossing gradual changing part 14; the depth D in the embossing main gradual changing part uniformly changes gradually across the top 11a of the embossing projected part 11 and the embossing non-projected part 12, and the embossing main gradual changing part comprises a embossing gradual changing distance which is the longest distance from the top 11a of the embossing projected part 11 to the embossing non-projected part 12 viewing in a plan-view, the embossing main gradual changing part comprises a embossing main gradual changing direction which is a direction of the embossing gradual changing distance.

Moreover, the embossing mold material 13 may comprise a plurality pieces of the embossing gradual changing part 14, in each which the embossing main gradual changing part is provided; the embossing main gradual changing direction, on the embossing main gradual changing part of at least two pieces of the embossing gradual changing part 14, in the embossing main gradual changing part of the plurality pieces of the embossing gradual changing part 14, are in approximately parallel mutually, the embossing main gradual changing direction on the embossing main gradual changing part may be curved.

Then, in the embossing mold material 13, the embossing projected part 11, the embossing gradual changing part 14, and/or the embossing main gradual changing part may join, branch, mutually intersect other embossing projected part 11, other embossing gradual changing part 14, other embossing main gradual changing part in the middle (that is, the embossing projected part 11, the embossing gradual changing part 14, the embossing main gradual changing part may comprise a joining portion, a branching portion, an intersecting portion). And, one piece of the embossing projected part 11, the embossing gradual changing part 14, the embossing main gradual changing part may comprise a plurality pieces of the joining portion, the branching portion, the intersecting portion.

### <The Others>

The present invention is not limited the above-mentioned embodiments. Each constitution, whole construction, shape and/or dimension of the sheet material 1, the producing method of the sheet material, the embossing mold material 13 et cetera can change appropriately in accordance with a purport of the present invention.

The sheet material 1 may comprise, the above-mentioned skin material 7 and the like, a backing member, which is laminated on the back face 2b side of the cushion base material 2 and so on.

The sheet material 1 don't have to comprise the above-mentioned obtuse angle face portion 6a and/or the wide angle face portion 6b, which is provided on the gradual changing part 5.

The sheet material 1 don't have to comprise the skin material 7, may comprise the pile on the surface 1a side of the sheet material 1.

The gradual changing part 5, as mentioned above, may comprise an approximately flat portion which a change amount of the height H is of 0 (zero), and which is approximately along the horizontal direction while it reached the bottom 3a of the recessed part 3 to the non-recessed part 4, the gradual changing part 5 may comprise a plurality of the approximately flat portions.

And, the sheet material 1 may comprise the recessed part 3, which is an approximately circular shape viewing in a plan-view, and the non-recessed part 4, which raises in approximately circular shape viewing in a plan-view and which is the raised top portion, the recessed part 3 and the non-recessed part 4 may be formed to be continuous along mutually approximately orthogonal direction, such as a longitudinal direction and a lateral direction et cetera (the sheet material 1 may comprise a profile design).

If the sheet material 1 comprise the recessed part 3, the non-recessed part 4, the gradual changing part 5, the above-mentioned producing method of the sheet material may comprise the embossing process E, producing by the embossing mold material 13 in addition to, for example, may cut down the cushion base material 2, the skin material 7 et cetera, may form by melting et cetera.

In the embossing process E of the producing method of the sheet material, the underlay sheet 30 don't have to be laid under the cushion base material 2, the embossing projected part 11 may be pressed toward the surface (the surface 2a, the surface 7a of the skin material 7) side of the cushion base material 2.

The producing method of the sheet material may include the embossing process E in addition to at least one process, such as a laminating process to laminate the skin material 7 to the surface 2a side of the cushion base material 2 on the embossing receiving mold 20 before the embossing process E, a cutting process to cut the sheet material 1 which the recessed part 3 is formed after the embossing process E.

The producing method of the sheet material, the embossing mold material 13 don't have to comprise the above-mentioned embossing wide angle portion 15a and/or the embossing obtuse angle face portion 15b which are provided on the embossing gradual changing part 14.

### INDUSTRIAL APPLICABILITY

The sheet material of the present invention can be used for products of vehicle interior use, such as an interior material such as an ornament (a door trim and so on), an arm rest, an instrument panel, a seat cover which covers a seat (chair) in automobile, watercraft, railroad cars, aircraft et cetera and the like, the sheet material of the present invention is available to industrial material use, interior use, clothing use, clothing material use and so on.

The sheet material of the producing method of the present invention also can be used the sheet materials by the producing method for vehicle interior use, such as an interior material such as an ornament (a door trim and so on), an arm rest, an instrument panel, a seat cover which covers a seat (chair) in automobile, watercraft, railroad cars, aircraft et cetera and the like, the sheet material by the producing method of the present invention is available to industrial material use, interior use, clothing use, clothing material use and so on.

The embossing mold material of the present invention also can be used the sheet materials produced by the embossing mold material for vehicle interior use, such as an interior material such as an ornament (a door trim and so on), an arm rest, an instrument panel, a seat cover which covers a seat (chair) in automobile, watercraft, railroad cars, aircraft et cetera and the like, the sheet material produced by the embossing mold material of the present invention is available to industrial material use, interior use, clothing use, clothing material use and so on.

### EXPLANATION OF NUMERALS AND SYMBOLS

1 sheet material
2 cushion base material
3 recessed part
4 non-recessed part
5 gradual changing part
6a obtuse angle face portion
6b wide angle face portion
7 skin material
8 main gradual changing part
11 embossing projected part
12 embossing non-projected part
13 embossing mold material
14 embossing gradual changing part
H height from bottom of recessed part
θa angle between obtuse angle face portion and surface of recessed part
θb angle between wide angle face portion and surface of non-recessed part
E embossing process
D depth from top of embossing projected part

1. A sheet material comprising:
at least one recessed part;
at least one non-recessed part; and
at least one gradual changing part, wherein
the at least one recessed part and the at least one non-recessed part are formed on a surface side of a cushion base material, and
in the at least one gradual changing part, a height from a bottom of the recessed part changes gradually across the recessed part and the non-recessed part.

2. The sheet material as claimed in claim 1, wherein
the sheet material comprises at least one obtuse angle face portion which is formed on at least a part of a near part to the bottom of the recessed part in the gradual changing part, an angle between the obtuse angle face portion and a bottom surface of the recessed part is 160 degrees or more and less than 180 degrees, and/or,
the sheet material comprises at least one wide angle face portion which is formed on at least a part of a near part to a surface of the non-recessed part in the gradual changing part, an angle between the wide angle face portion and the non-recessed part is more than 180 degrees and 200 degrees or less.

3. The sheet material as claimed in claim 1, wherein
the sheet material comprises at least one skin material which is laminated on the surface side of the cushion base material, and
the recessed part is formed by recessing the skin material and also the cushion base material.

4. The sheet material as claimed in claim 3, wherein
the skin material is formed from a raw material of thermoplastic, and
the non-recessed part has at least one portion formed so as not to degenerate the skin material.

5. The sheet material as claimed in claim 1, wherein
the cushion base material is a double raschel knitting fabric.

6. The sheet material as claimed in claim 1, wherein
the sheet material comprises at least one main gradual changing part which is provided in at least one part of the gradual changing part,
the height in the main gradual changing part uniformly changes gradually across the recessed part and the non-recessed part,
the main gradual changing part comprises a gradual changing distance which is the longest distance from the bottom of the recessed part to the non-recessed part viewed in a plan-view, and
the main gradual changing part comprises a main gradual changing direction which is a direction of the gradual changing distance.

7. The sheet material as claimed in claim 6, wherein
the sheet material comprises a plurality of pieces of the gradual changing parts, in each of which the main gradual changing part is provided, and
the main gradual changing directions, on the main gradual changing parts of at least two pieces of the gradual changing parts, in the main gradual changing parts of the plurality of pieces of the gradual changing parts, are approximately mutually parallel.

8. The sheet material as claimed in claim 6, wherein
the main gradual changing direction on the main gradual changing part is curved.

9. A producing method of a sheet material characterized by the following:
the producing method comprises an embossing process pressing at least one embossing mold material, in which at least one embossing projected part and at least one embossing non-projected part are formed, to a surface side of at least one cushion base material;
the producing method is a producing method producing at least one sheet material in which at least one recessed part and at least one non-recessed part are formed on a surface side of the cushion base material;
the embossing mold material comprises at least one embossing gradual changing part in which a depth, from a top of the embossing projected part, changes gradually across the embossing projected part and the embossing non-projected part; and
in the embossing process, the embossing mold material is pressed in a situation that the embossing projected part and the embossing gradual changing part are abutting to the surface side of the cushion base material.

10. A embossing mold material characterized by the following:
the embossing mold material comprises at least one embossing projected part and at least one embossing non-projected part which are formed on the embossing mold material; and
the embossing mold material comprises at least one embossing gradual changing part in which a depth, from a top of the embossing projected part, changes gradually across the embossing projected part and the embossing non-projected part.
